(19) United States
(12) Patent Application Publication
(10) Pub. No.: US 2020/0154124 A1
(43) Pub. Date: May 14, 2020

(54) IMAGE DECODING METHOD BASED ON INTER PREDICTION AND IMAGE DECODING APPARATUS THEREFOR

(71) Applicant: LG ELECTRONICS INC., Seoul (KR)

(72) Inventors: Jaeho LEE, Seoul (KR); Jungdong SEO, Seoul (KR); Jaehyun LIM, Seoul (KR)

(21) Appl. No.: 16/628,602

(22) PCT Filed: Jun. 22, 2018
(86) PCT No.: PCT/KR2018/007103

§ 371 Date: Jan. 3, 2020

Related U.S. Application Data
(60) Provisional application No. 62/528,454, filed on Jul. 4, 2017.

(51) Int. Cl. H04N 19/503; H04N 19/176; H04N 19/105; H04N 19/44

(52) U.S. Cl. CPC H04N 19/503; H04N 19/44; H04N 19/105; H04N 19/176

(57) ABSTRACT

An image decoding method based on an inter prediction is disclosed. The image decoding method according to an embodiment of the present disclosure includes deriving first motion information of a current block by applying template matching on the current block; determining whether to perform the template matching in subblock units of the current block; if it is determined not to perform the template matching in the subblock units, generating a prediction block of the current block by using the first motion information; if it is determined to perform the template matching in the subblock units, deriving second motion information in subblock units by performing the template matching on a subblock of the current block; and generating a prediction block of the current block by using the derived first motion information and the derived second motion information. The template matching is a mode deriving motion information minimizing a difference value between a neighbor template region of the current block and a neighbor template region of a reference block of a reference picture.

### TECHNICAL FIELD

The present disclosure relates to a still image or a video processing method, more particularly, to a still image or a video encoding/decoding method by deriving a motion vector based on an inter prediction mode, and an apparatus for supporting the same.

### BACKGROUND ART

Compression encoding means a series of signal processing techniques for transmitting digitized information through a communication line or techniques for storing information in a form suitable for a storage medium. The medium including a picture, an image, audio, etc. may be a target for compression encoding, and particularly, a technique for performing compression encoding on a picture is referred to as video image compression.

Next-generation video contents are supposed to have the characteristics of high spatial resolution, a high frame rate and high dimensionality of scene representation. In order to process such contents, a drastic increase in the memory storage, memory access rate and processing power will result.

Accordingly, it is required to design a coding tool for processing next-generation video contents efficiently.

### DISCLOSURE

### Technical Problem

In the existing template matching method, template matching is performed in coding block units in an encoder/decoder, and then the template matching is performed in subblock units. However, in the case of always performing the template matching in the subblock units, compression performance may be deteriorated under a specific condition (for example, when motion is not large). In addition, when always performing the template matching in the subblock units, complexity of the encoder/decoder increases. That is, in some cases, the compression performance may be improved by skipping the template matching in the subblock units and performing only the template matching in the coding block units.

In order to solve the above problems, in a process of the encoder/decoder derives a motion vector using the template matching, an object of the present disclosure is to provide a method and apparatus for determining whether to perform the template matching in the subblock units.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

In one aspect of the present disclosure, an image decoding method based on an inter prediction, includes: deriving first motion information of a current block by applying template matching on the current block, wherein the template matching is a mode deriving motion information minimizing a difference value between a neighbor template region of the current block and a neighbor template region of a reference block of a reference picture; determining whether to perform the template matching in subblock units of the current block; if it is determined not to perform the template matching in the subblock units, generating a prediction block of the current block by using the first motion information; if it is determined to perform the template matching in the subblock units, deriving second motion information in subblock units by performing the template matching on a subblock of the current block; and if it is determined to perform the template matching in the subblock units, generating a prediction block of the current block by using the first motion information and the second motion information.

Preferably, the neighbor template region of the current block may include upper neighbor samples of the current block and/or left-side neighbor samples of the current block, and the neighbor template region of the reference block may include upper neighbor samples of the reference block and/or left-side neighbor samples of the reference block.

Preferably, when determining whether to perform the template matching in subblock units of the current block, it may be determined to perform the template matching in the subblock units if a first predictor which is generated by performing an inter prediction based on a reference picture included in a reference picture list 0 and a second predictor which is generated by performing an inter prediction based on a reference picture included in a reference picture list 1 are both generated by using only reference pictures outputted temporally prior to a current picture, or both generated by using only reference pictures outputted temporally later than the current picture.

Preferably, when determining whether to perform the template matching in subblock units of the current block, it may be determined not to perform the template matching in the subblock units if each of a first predictor which is generated by performing an inter prediction based on a reference picture included in a reference picture list 0 and a second predictor which is generated by performing an inter prediction based on a reference picture included in a reference picture list 1 is generated by using a reference picture outputted temporally prior to a current picture and a reference picture outputted temporally later than the current picture.

Preferably, when determining whether to perform the template matching in subblock units of the current block, it may be determined to perform the template matching in the subblock units if a reference picture list of the current block only includes reference pictures outputted temporally prior to a current picture.

Preferably, when determining whether to perform the template matching in subblock units of the current block, it may be determined not to perform the template matching in the subblock units if a reference picture of the current block included in a reference picture list includes only a reference picture outputted temporally later than a current picture, or includes both a reference picture outputted temporally prior to the current picture and a reference picture outputted temporally later than the current picture.

Preferably, when determining whether to perform the template matching in subblock units of the current block, it may be determined to perform the template matching in the subblock units if a reference picture list of the current block includes only reference pictures outputted temporally prior to a current picture, when the reference picture list of the current block includes only reference pictures outputted temporally later than the current picture or includes both a reference picture outputted temporally prior to the current picture and a reference picture outputted temporally later than the current picture, it may be determined not to perform the template matching in the subblock units if a first predictor which is generated by performing an inter prediction based on a reference picture included in a reference picture list 0 and a second predictor which is generated by performing an inter prediction based on a reference picture included in a reference picture list 1 are generated by using a reference picture outputted temporally prior to the current picture and a reference picture outputted temporally later than the current picture, and it may be determined to perform the template matching in the subblock units if the first predictor and the second predictor are both generated by using only reference pictures outputted temporally prior to the current picture, or both generated by using only reference pictures outputted temporally later than the current picture.

Preferably, the deriving the second motion information in subblock units may further include: partitioning the current block into a plurality of subblocks having the same size; acquiring the first motion information as temporary motion information of the plurality of subblocks; and deriving the second motion information by applying the template matching in subblock units based on the first motion information, wherein the template matching may be applied on each of left-side subblocks and/or upper subblocks that are adjacent to the neighbor template region of the current block among the plurality of subblocks.

Preferably, when deriving the second motion information by applying the template matching in subblock units based on the first motion information, motion information which minimizes a difference value between a neighbor template region of the left-side subblocks and/or a neighbor template region of the upper subblocks and, a neighbor template region of adjacent region of a reference block identified by the first motion information may be derived as a final motion information of the subblock.

Preferably, the deriving first motion information of a current block by applying template matching on the current block may further include: constructing a motion vector candidate list based on motion information of a decoded neighbor block of the current block; acquiring a difference value between a neighbor template region of a reference block indicated by a motion vector included in the motion vector candidate list on each of motion vectors included in the motion vector candidate list and the neighbor template region of the current block; determining a motion vector having a minimum difference value among the motion vectors included in the motion vector candidate list as a temporary motion vector; and determining a motion vector minimizing a difference value a difference value between a neighbor template region of adjacent region of a reference block identified by the temporary motion vector and the neighbor template region of the current block as the first motion information.

Preferably, the method may further include: identifying whether an inter prediction mode of the current block is a merge mode which is a mode deriving motion information of the current block using spatially or temporally neighboring block of the current block; if the inter prediction mode of the current block is the merge mode, identifying whether a DSMVD mode is applied to the current block, wherein the DSMVD mode indicates a mode in which a decoder derives motion information without transmitting motion-related information; and if the DSMVD mode is applied to the current block, identifying whether the template matching is applied to the current block.

In one aspect of the present disclosure, an image decoding apparatus based on an inter prediction, includes: a first motion information derivation unit for deriving first motion information of a current block by applying template matching on the current block, wherein the template matching is a mode deriving motion information minimizing a difference value between a neighbor template region of the current block and a neighbor template region of a reference block of a reference picture; a determination unit for determining whether to perform the template matching in subblock units of the current block; a second motion information derivation unit for deriving second motion information in subblock units by performing the template matching on a subblock of the current block if it is determined to perform the template matching in the subblock units; and a prediction block generation unit for generating a prediction block of the current block by using the first motion information if it is determined not to perform the template matching in the subblock units, and if it is determined to perform the template matching in the subblock units, generating a prediction block of the current block by using the first motion information and the second motion information.

### Advantageous Effects

According to an embodiment of the present disclosure, in some cases, it is possible to improve the accuracy of prediction and the compression performance, and to reduce the complexity of the encoder/decoder by skipping the template matching in subblock units.

According to an embodiment of the present disclosure, if the current block is true bi-prediction, it is possible to improve the accuracy of prediction and the compression performance by skipping the template matching in subblock units.

In addition, according to an embodiment of the present disclosure, if the current block is not an LD case (low delay case), it is possible to improve the accuracy of prediction and the compression performance by skipping the template matching in subblock units.

In addition, according to an embodiment of the present disclosure, by considering whether the current block is true bi-prediction or not an LD case, it is possible to reduce the complexity and improve the compression performance.

Advantages which can be obtained in the present disclosure are not limited to the aforementioned effects and other unmentioned advantages will be clearly understood by those skilled in the art from the following description.

### DESCRIPTION OF DRAWINGS

The accompanying drawings, which are included herein as a part of the description for help understanding the present disclosure, provide embodiments of the present disclosure, and describe the technical features of the present disclosure with the description below.

FIG. 1 is a schematic block diagram of an encoder in which the encoding of a still image or video signal is performed, as an embodiment to which the present disclosure is applied.

FIG. 2 illustrates a schematic block diagram of a decoder in which decoding of a still image or video signal is performed, as an embodiment to which the present disclosure is applied.

FIG. 3 is a diagram for describing a split structure of a coding unit that may be applied to the present disclosure.

FIG. 4 is a diagram for describing a prediction unit that may be applied to the present disclosure.

FIG. 5 is an embodiment to which the present disclosure may be applied and is a diagram illustrating the direction of inter-prediction.

FIG. 6 is an embodiment to which the present disclosure may be applied and illustrates integers for ¼ sample interpolation and fraction sample locations.

FIG. 7 is an embodiment to which the present disclosure may be applied and illustrates the location of a spatial candidate.

FIG. 8 is an embodiment to which the present disclosure is applied and is a diagram illustrating an inter-prediction method.

FIG. 9 is an embodiment to which the present disclosure may be applied and is a diagram illustrating a motion compensation process.

FIG. 10 is a diagram for describing template matching according to an embodiment of the present disclosure.

FIG. 11 illustrates that template matching is performed on subblocks after template matching is performed on a coding block according to an embodiment of the present disclosure.

FIG. 12 illustrates a template and subblocks on which template matching is performed according to an embodiment of the present disclosure.

FIGS. 13 and 14 are diagrams for describing a bi-lateral matching according to an embodiment of the present disclosure.

FIG. 15 illustrates a flowchart of an encoding procedure according to an embodiment of the present disclosure.

FIG. 16 illustrates a flowchart of a decoding procedure according to an embodiment of the present disclosure.

FIG. 17 illustrates a flowchart of processes of performing template matching on a coding block and a subblock according to an embodiment of the present disclosure.

FIG. 18 illustrates a flowchart of processes of selectively performing template matching in subblock units according to an embodiment of the present disclosure.

FIG. 19 illustrates a flowchart of processes of selectively performing template matching in subblock units according to another embodiment of the present disclosure.

FIG. 20 is a flowchart of processes of selectively performing template matching on a subblock after template matching is performed on a coding block according to another embodiment of the present disclosure.

FIG. 21 is a block diagram of an inter prediction unit according to an embodiment of the present disclosure.

FIG. 22 is a flowchart of an image decoding method based on an inter prediction according to an embodiment of the present disclosure.

### MODE FOR INVENTION

Hereinafter, a preferred embodiment of the present disclosure will be described by reference to the accompanying drawings. The description that will be described below with the accompanying drawings is to describe exemplary embodiments of the present disclosure, and is not intended to describe the only embodiment in which the present disclosure may be implemented. The description below includes particular details in order to provide perfect understanding of the present disclosure. However, it is understood that the present disclosure may be embodied without the particular details to those skilled in the art.

In some cases, in order to prevent the technical concept of the present disclosure from being unclear, structures or devices which are publicly known may be omitted, or may be depicted as a block diagram centering on the core functions of the structures or the devices.

Further, although general terms widely used currently are selected as the terms in the present disclosure as much as possible, a term that is arbitrarily selected by the applicant is used in a specific case. Since the meaning of the term will be clearly described in the corresponding part of the description in such a case, it is understood that the present disclosure will not be simply interpreted by the terms only used in the description of the present disclosure, but the meaning of the terms should be figured out.

Specific terminologies used in the description below may be provided to help the understanding of the present disclosure. Furthermore, the specific terminology may be modified into other forms within the scope of the technical concept of the present disclosure. For example, a signal, data, a sample, a picture, a frame, a block, etc may be properly replaced and interpreted in each coding process.

Hereinafter, in this specification, a ‘block’ or ‘unit’ means a unit in which an encoding/decoding processing process, such as prediction, transform and/or quantization, is performed, and may be consist of multi-dimensional array of sample (or pixel).

A term ‘block’ or ‘unit’ may be referred to a multidimensional array of samples for luma components, and also a multidimensional array of samples for chroma components. In addition, the term ‘block’ or ‘unit’ may be collectively referred to as including both the multidimensional array of samples for luma components and the multidimensional array of samples for chroma components.

For example, the term ‘block’ or ‘unit’ may be interpreted to include all of a coding block (CB) that means an array of samples to be encoded/decoded, a coding tree block (CTB) composed of a plurality of coding blocks, a prediction block (PB) (or a prediction unit (PU)) that means an array of samples to which the same prediction is applied, and a transform block (TB) (or a transform unit (TU)) that means an array of samples to which the same transformation is applied.

In addition, unless stated otherwise in the present disclosure, the term ‘block’ or ‘unit’ may be interpreted to include a syntax structure used in encoding/decoding an array of samples for luma and/or chroma components. Here, the syntax structure refers to 0 or more syntax elements existing in the bitstream in a specific order, and the syntax element refers to an element of data represented in the bitstream.

For example, the term ‘block’ or ‘unit’ may be interpreted to include all of a coding unit (CU) including a coding block (CB) and a syntax structure used for encoding the corresponding coding block (CB), a coding tree unit (CTU) composed of a plurality of coding units, a prediction unit (PU) including a prediction block (PB) and a syntax structure used for prediction of the corresponding prediction block (PB), and a transform unit (TU) including a transform block (TB) and a syntax structure used for transforming the corresponding transform block (TB).

In addition, in the present disclosure, the term ‘block’ or ‘unit’ is not necessarily limited to an array of samples (or pixels) in the form of squares or rectangles, and may also mean an array of samples (or pixels) in the form of polygons having three or more vertices. In this case, it may also be referred to as a polygon block or a polygon unit.

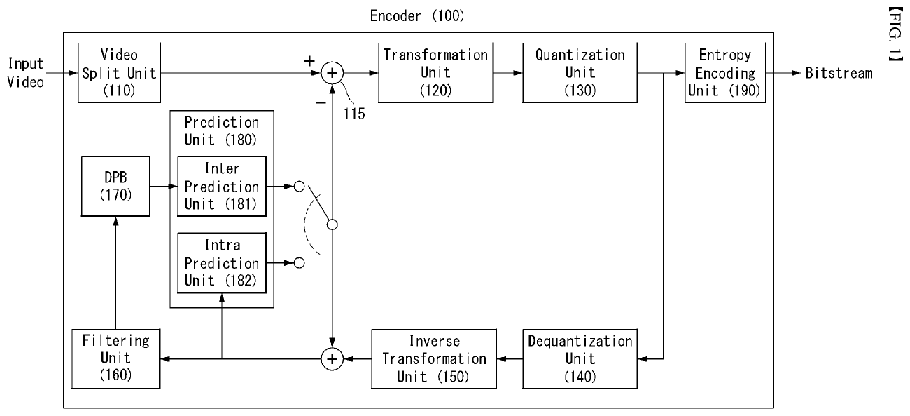

FIG. 1 is a schematic block diagram of an encoder in which the encoding of a still image or video signal is performed, as an embodiment to which the present disclosure is applied.

Referring to FIG. 1, the encoder 100 may include a video split unit 110, a subtractor 115, a transformation unit 120, a quantization unit 130, a dequantization unit 140, an inverse transformation unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture, frame), input to the encoder 100, into one or more blocks.

The subtractor 115 generates a residual signal (or residual block) by subtracting a predicted signal (or predicted block) outputted from the prediction unit 180 (i.e., by the inter-prediction unit 181 or the intra-prediction unit 182), from the input video signal. The generated residual signal (or residual block) is transmitted to the transformation unit 120.

The transformation unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transformation unit 120 may generate transform coefficients by performing transform using a prediction mode applied to the residual block and a transform scheme determined based on the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal outputted by the quantization unit 130 may be used to generate a prediction signal. For example, a residual signal may be reconstructed by applying dequantization and inverse transformation to the quantized signal through the dequantization unit 140 and the inverse transformation unit 150. A reconstructed signal may be generated by adding the reconstructed residual signal (or reconstructed block) to the prediction signal output by the inter-prediction unit 181 or the intra-prediction unit 182.

Meanwhile, during such a compression process, neighbor blocks are quantized by different quantization parameters. Accordingly, an artifact in which a block boundary is shown may occur. Such a phenomenon is referred to a blocking artifact, which is one of important factors for evaluating image quality. In order to decrease such an artifact, a filtering process may be performed. Through such a filtering process, the blocking artifact is removed and the error of a current picture is decreased at the same time, thereby improving image quality.

The filtering unit 160 applies filtering to the reconstructed signal, and outputs it through a playback device or transmits it to the decoded picture buffer 170. The filtered signal transmitted to the decoded picture buffer 170 may be used as a reference picture in the inter-prediction unit 181. As described above, an encoding rate as well as image quality can be improved using the filtered picture as a reference picture in an inter-picture prediction mode.

The decoded picture buffer 170 may store the filtered picture in order to use it as a reference picture in the inter-prediction unit 181.

The inter-prediction unit 181 performs temporal prediction and/or spatial prediction with reference to the reconstructed picture in order to remove temporal redundancy and/or spatial redundancy. In this case, a blocking artifact or ringing artifact may occur because a reference picture used to perform prediction is a transformed signal that experiences quantization or dequantization in a block unit when it is encoded/decoded previously.

Accordingly, in order to solve performance degradation attributable to the discontinuity of such a signal or quantization, signals between pixels may be interpolated in a sub pixel unit by applying a low pass filter to the inter-prediction unit 181. In this case, the sub pixel means a virtual pixel generated by applying an interpolation filter, and an integer pixel means an actual pixel that is present in a reconstructed picture. A linear interpolation, a bi-linear interpolation, a wiener filter, and the like may be applied as an interpolation method.

The interpolation filter may be applied to the reconstructed picture, and may improve the accuracy of prediction. For example, the inter-prediction unit 181 may perform prediction by generating an interpolation pixel by applying the interpolation filter to the integer pixel and by using the interpolated block including interpolated pixels as a prediction block.

The intra-prediction unit 182 predicts a current block with reference to samples neighboring to the block that is now to be encoded. The intra-prediction unit 182 may perform the following procedure in order to perform intra-prediction. First, the intra-prediction unit 182 may prepare a reference sample necessary to generate a prediction signal. Furthermore, the intra-prediction unit 182 may generate a predicted signal (predicted block) using the prepared reference sample. Next, the intra-prediction unit 182 may encode a prediction mode. In this case, the reference sample may be prepared through reference sample padding and/or reference sample filtering. A quantization error may be present because the reference sample experiences the prediction and the reconstruction process. Accordingly, in order to reduce such an error, a reference sample filtering process may be performed on each prediction mode used for the intra-prediction.

The predicted signal (or predicted block) generated through the inter-prediction unit 181 or the intra-prediction unit 182 may be used to generate a reconstructed signal (or reconstructed block) or may be used to generate a residual signal (or residual block).

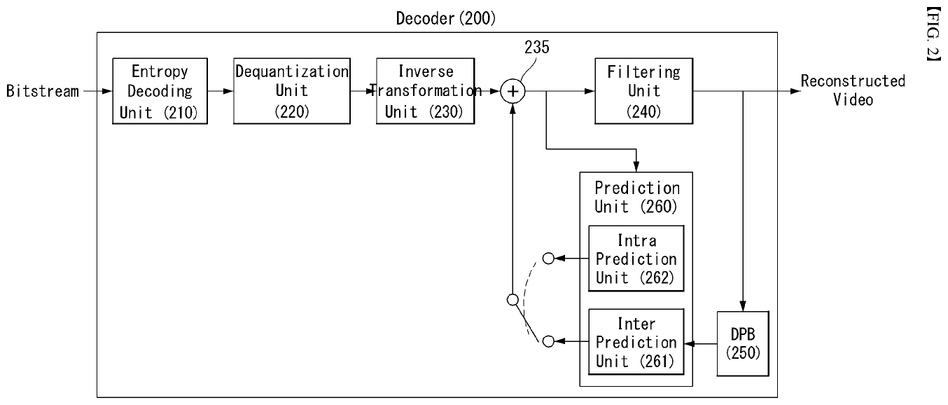

FIG. 2 illustrates a schematic block diagram of a decoder in which decoding of a still image or video signal is performed, as an embodiment to which the present disclosure is applied.

Referring to FIG. 2, the decoder 200 may include an entropy decoding unit 210, a dequantization unit 220, an inverse transformation unit 230, an adder 235, a filtering unit 240, a decoded picture buffer (DPB) 250 and a prediction unit 260. Furthermore, the prediction unit 260 may include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 shown in FIG. 1. The entropy decoding unit 210 performs an entropy decoding operation on the received signal.

The dequantization unit 220 obtains transform coefficients from the entropy-decoded signal using quantization step size information.

The inverse transformation unit 230 obtains a residual signal (or residual block) by inverse transforming the transform coefficients by applying an inverse transform scheme.

The adder 235 adds the obtained residual signal (or residual block) to the predicted signal (or predicted block) output by the prediction unit 260 (i.e., the inter-prediction unit 261 or the intra-prediction unit 262), thereby generating a reconstructed signal (or reconstructed block).

The filtering unit 240 applies filtering to the reconstructed signal (or reconstructed block) and outputs the filtered signal to a playback device or transmits the filtered signal to the decoded picture buffer 250. The filtered signal transmitted to the decoded picture buffer 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

As described above, the embodiments described in the present disclosure may be implemented and performed on a processor, a micro processor, a controller or a chip. For example, the function units shown in each of drawings may be implemented and performed on a computer, a processor, a micro processor, a controller, or a chip.

Furthermore, the decoder and the encoder to which the present disclosure is applied may be included in a multimedia broadcasting transmission and reception device, a mobile communication terminal, a home cinema video device, a digital cinema video device, a camera for monitoring, a video dialogue device, a real-time communication device such as video communication, a mobile streaming device, a storage medium, a camcorder, a video on-demand (VoD) service provision device, over the top (OTT) video device, an Internet streaming service provision device, a three-dimensional (3D) video device, a video telephony device, and a medical video device, and may be used to process a video signal or a data signal. For example, over the top (OTT) video device may comprise a game console, a blu-ray player, Internet access TV, home theater system, smartphone, tablet PC, digital video recorder (DVR).

Furthermore, the processing method to which the present disclosure is applied may be produced in the form of a program executed by a computer, and may be stored in a computer-readable recording medium. Multimedia data having a data structure according to the present disclosure may also be stored in a computer-readable recording medium. The computer-readable recording medium includes all types of storage devices and distribution storage devices in which computer-readable data is stored. The computer-readable recording medium may include Blueray disk (BD), a universal serial bus (USB), ROM, PROM, EPROM, EEPROM, RAM, CD-ROM, a magnetic tape, a floppy disk, and an optical data storage device, for example. Furthermore, the computer-readable recording medium includes media implemented in the form of carriers (e.g., transmission through the Internet). Furthermore, a bit stream generated using an encoding method may be stored in a computer-readable recording medium or may be transmitted over wired and wireless communication networks.

Furthermore, the embodiment of the present disclosure may be implemented as a computer program product based on program code. The program code may be performed in a computer according to the embodiment of the present disclosure. The program code may be stored on a computer-readable carrier.

A content streaming system to which the present disclosure is applied may basically include an encoding server, a streaming server, a web server, a media storage, a user equipment and a multimedia input device.

The encoding server functions to generate a bit stream by compressing content received from multimedia input devices, such as a smartphone, a camera, and a camcorder, into digital data, and to transmit the digital data to the streaming server. For another example, if multimedia input devices, such as a smartphone, a camera, and a camcorder, directly generate a bit stream, the encoding server may be omitted.

The bit stream may be generated by an encoding method or bit stream generation method to which the present disclosure is applied, and the streaming server may temporarily store the bit stream in a process of transmitting or receiving the bit stream.

The streaming server transmits multimedia data to the user equipment based on a user request through the web server, and the web server plays a role of a medium for notifying a user that which service is present. When the user requests a desired service from the web server, the web server transmits the desired service to the streaming server, and the streaming server transmits multimedia data to the user. In this case, the content streaming system may include a separate control server. In this case, the control server functions to control an instruction/response between devices within the content streaming system.

The streaming server may receive content from the media storage and/or the encoding server. For example, if content is received from the encoding server, the streaming server may receive the content in real time. In this case, in order to provide a smooth streaming service, the streaming server may store the bit stream for a given time.

Examples of the user equipment may include a mobile phone, a smartphone, a laptop computer, a terminal for digital broadcasting, a personal digital assistants (PDA), a portable multimedia player (PMP), a navigator, a slate PC, a tablet PC, an ultrabook, a wearable device, (e.g., a watch type terminal (smart watch), a glass type terminal (smart glass), and a head mounted display (HMD)), digital TV, a desktop computer, and a digital signage.

Each of the servers within the content streaming system may operate as a distributed server. In this case, data received from the servers may be distributed and processed.

Block Partition Structure

In general, a block-based image compression method is used in the compression technique (e.g., HEVC) of a still image or a video. The block-based image compression method is a method of processing an image by splitting it into specific block units, and may decrease memory use and a computational load.

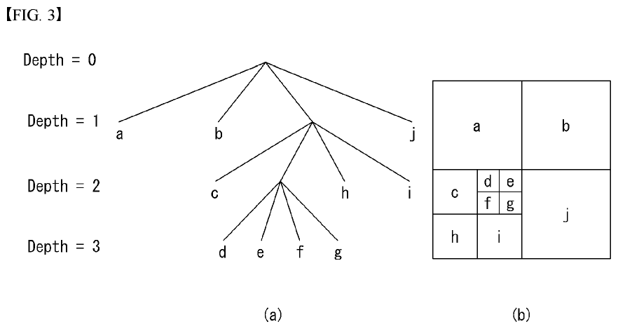

FIG. 3 is a diagram for describing a split structure of a coding unit which may be applied to the present disclosure.

An encoder splits a single image (or picture) into coding tree units (CTUs) of a quadrangle form, and sequentially encodes the CTUs one by one according to raster scan order.

In HEVC, a size of CTU may be determined as one of 64×64, 32×32, and 16×16. The encoder may select and use the size of a CTU based on resolution of an input video signal or the characteristics of input video signal. The CTU includes a coding tree block (CTB) for a luma component and the CTB for two chroma components that correspond to it.

One CTU may be split in a quad-tree structure. That is, one CTU may be split into four units each having a square form and having a half horizontal size and a half vertical size, thereby being capable of generating coding units (CUs). Such splitting of the quad-tree structure may be recursively performed. That is, the CUs are hierarchically split from one CTU in the quad-tree structure.

A CU means a basic unit for the processing process of an input video signal, for example, coding in which intra/inter prediction is performed. A CU includes a coding block (CB) for a luma component and a CB for two chroma components corresponding to the luma component. In HEVC, a CU size may be determined as one of 64×64, 32×32, 16×16, and 8×8.

Referring to FIG. 3, the root node of a quad-tree is related to a CTU. The quad-tree is split until a leaf node is reached. The leaf node corresponds to a CU.

More specifically, the CTU corresponds to the root node and has the smallest depth (i.e., depth=0) value. A CTU may not be split depending on the characteristics of an input video signal. In this case, the CTU corresponds to a CU.

A CTU may be partitioned in a quad-tree form. As a result, lower nodes, that is, a depth 1 (depth=1), are generated. Furthermore, a node (i.e., leaf node) that belongs to the lower nodes having the depth of 1 and that is no longer partitioned corresponds to a CU. For example, in FIG. 3(b), a CU(a), a CU(b) and a CU(j) corresponding to nodes a, b and j have been once partitioned from the CTU, and have a depth of 1.

At least one of the nodes having the depth of 1 may be partitioned in a quad-tree form. As a result, lower nodes having a depth 1 (i.e., depth=2) are generated. Furthermore, a node (i.e., leaf node) that belongs to the lower nodes having the depth of 2 and that is no longer partitioned corresponds to a CU. For example, in FIG. 3(b), a CU(c), a CU(h) and a CU(i) corresponding to nodes c, h and i have been twice partitioned from the CTU, and have a depth of 2.

Furthermore, at least one of the nodes having the depth of 2 may be partitioned in a quad-tree form again. As a result, lower nodes having a depth 3 (i.e., depth=3) are generated. Furthermore, a node (i.e., leaf node) that belongs to the lower nodes having the depth of 3 and that is no longer partitioned corresponds to a CU. For example, in FIG. 3(b), a CU(d), a CU(e), a CU(f) and a CU(g) corresponding to nodes d, e, f and g have been three times partitioned from the CTU, and have a depth of 3.

In the encoder, a maximum size or minimum size of a CU may be determined based on the characteristics of a video image (e.g., resolution) or by considering the encoding rate. Furthermore, information about the maximum or minimum size or information capable of deriving the information may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents a split count and/or degree of a CU, it may include information about the size of a CU.

Since the LCU is split in a Quad-tree shape, the size of SCU may be obtained by using a size of LCU and the maximum depth information. Or, inversely, the size of LCU may be obtained by using a size of SCU and the maximum depth information of the tree.

For a single CU, the information (e.g., a split CU flag (split cu flag)) that represents whether the corresponding CU is split may be forwarded to the decoder. This split information is included in all CUs except the SCU. For example, when the value of the flag that represents whether to split is ‘1’, the corresponding CU is further split into four CUs, and when the value of the flag that represents whether to split is ‘0’, the corresponding CU is not split any more, and the processing process for the corresponding CU may be performed.

As described above, a CU is a basic unit of the coding in which the intra-prediction or the inter-prediction is performed. The HEVC splits the CU in a prediction unit (PU) for coding an input video signal more effectively.

A PU is a basic unit for generating a prediction block, and even in a single CU, the prediction block may be generated in different way by a unit of PU. However, the intra-prediction and the inter-prediction are not used together for the PUs that belong to a single CU, and the PUs that belong to a single CU are coded by the same prediction method (i.e., the intra-prediction or the inter-prediction).

A PU is not split in the Quad-tree structure, but is split once in a single CU in a predetermined shape. This will be described by reference to the drawing below.

FIG. 4 is a diagram for describing a prediction unit that may be applied to the present disclosure.

A PU is differently split depending on whether the intra-prediction mode is used or the inter-prediction mode is used as the coding mode of the CU to which the PU belongs.

FIG. 4(a) illustrates a PU if the intra-prediction mode is used, and FIG. 4(b) illustrates a PU if the inter-prediction mode is used.

Referring to FIG. 4(a), assuming that the size of a single CU is 2N×2N (N=4, 8, 16 and 32), the single CU may be split into two types (i.e., 2N×2N or N×N).

In this case, if a single CU is split into the PU of 2N×2N shape, it means that only one PU is present in a single CU.

Meanwhile, if a single CU is split into the PU of N×N shape, a single CU is split into four PUs, and different prediction blocks are generated for each PU unit. However, such PU splitting may be performed only if the size of CB for the luma component of CU is the minimum size (i.e., the case that a CU is an SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in the intra-prediction, the PU split of N×N shape may be performed only if the size of CB for the luma component of CU is the minimum size (i.e., the case that a CU is an SCU).

The inter-prediction supports the PU split in the shape of 2N×N that is split in a horizontal direction and in the shape ofN×2N that is split in a vertical direction.

In addition, the inter-prediction supports the PU split in the shape of nL×2N, nR×2N, 2N×nU and 2N×nD, which is an asymmetric motion split (AMP). In this case, ‘n’ means ¼ value of 2N. However, the AMP may not be used if the CU to which the PU is belonged is the CU of minimum size.

In order to encode the input video signal in a single CTU efficiently, the optimal split structure of the coding unit (CU), the prediction unit (PU) and the transform unit (TU) may be determined based on a minimum rate-distortion value through the processing process as follows. For example, as for the optimal CU split process in a 64×64 CTU, the rate-distortion cost may be calculated through the split process from a CU of 64×64 size to a CU of 8×8 size. The detailed process is as follows.

1) The optimal split structure of a PU and TU that generates the minimum rate distortion value is determined by performing inter/intra-prediction, transformation/quantization, dequantization/inverse transformation and entropy encoding on the CU of 64×64 size.

2) The optimal split structure of a PU and TU is determined to split the 64×64 CU into four CUs of 32×32 size and to generate the minimum rate distortion value for each 32×32 CU.

3) The optimal split structure of a PU and TU is determined to further split the 32×32 CU into four CUs of 16×16 size and to generate the minimum rate distortion value for each 16×16 CU.

4) The optimal split structure of a PU and TU is determined to further split the 16×16 CU into four CUs of 8×8 size and to generate the minimum rate distortion value for each 8×8 CU.

5) The optimal split structure of a CU in the 16×16 block is determined by comparing the rate-distortion value of the 16×16 CU obtained in the process 3) with the addition of the rate-distortion value of the four 8×8 CUs obtained in the process 4). This process is also performed for remaining three 16×16 CUs in the same manner.

6) The optimal split structure of CU in the 32×32 block is determined by comparing the rate-distortion value of the 32×32 CU obtained in the process 2) with the addition of the rate-distortion value of the four 16×16 CUs that is obtained in the process 5). This process is also performed for remaining three 32×32 CUs in the same manner.

7) Finally, the optimal split structure of CU in the 64×64 block is determined by comparing the rate-distortion value of the 64×64 CU obtained in the process 1) with the addition of the rate-distortion value of the four 32×32 CUs obtained in the process 6).

In the intra-prediction mode, a prediction mode is selected as a PU unit, and prediction and reconstruction are performed on the selected prediction mode in an actual TU unit.

A TU means a basic unit in which actual prediction and reconstruction are performed. A TU includes a transform block (TB) for a luma component and a TB for two chroma components corresponding to the luma component.

In the example of FIG. 3, as in an example in which one CTU is split in the quad-tree structure to generate a CU, a TU is hierarchically split from one CU to be coded in the quad-tree structure.

TUs split from a CU may be split into smaller and lower TUs because a TU is split in the quad-tree structure. In HEVC, the size of a TU may be determined to be as one of 32×32, 16×16, 8×8 and 4×4.

Referring back to FIG. 3, the root node of a quad-tree is assumed to be related to a CU. The quad-tree is split until a leaf node is reached, and the leaf node corresponds to a TU.

This is described in more detail. A CU corresponds to a root node and has the smallest depth (i.e., depth=0) value. A CU may not be split depending on the characteristics of an input image. In this case, the CU corresponds to a TU.

A CU may be split in a quad-tree form. As a result, lower nodes having a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TU(j) corresponding to the nodes a, b and j are once split from a CU and have a depth of 1.

At least one of the nodes having the depth of 1 may be split in a quad-tree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to the node c, h and I have been split twice from the CU and have the depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to the nodes d, e, f and g have been three times split from the CU and have the depth of 3.

A TU having a tree structure may be hierarchically split with predetermined maximum depth information (or maximum level information). Furthermore, each spit TU may have depth information. The depth information may include information about the size of the TU because it indicates the split number and/or degree of the TU.

Information (e.g., a split TU flag “split transform flag”) indicating whether a corresponding TU has been split with respect to one TU may be transferred to the decoder. The split information is included in all of TUs other than a TU of a minimum size. For example, if the value of the flag indicating whether a TU has been split is “1”, the corresponding TU is split into four TUs. If the value of the flag indicating whether a TU has been split is “0”, the corresponding TU is no longer split.

Prediction

In order to reconstruct a current processing unit on which decoding is performed, the decoded part of a current picture or other pictures including the current processing unit may be used.

A picture (slice) using only a current picture for reconstruction, that is, on which only intra prediction is performed, may be called an intra-picture or I picture (slice), a picture (slice) using a maximum of one motion vector and reference index in order to predict each unit may be called a predictive picture or P picture (slice), and a picture (slice) using a maximum of two motion vector and reference indices may be called a bi-predictive picture or B a picture (slice).

Intra-prediction means a prediction method of deriving a current processing block from the data element (e.g., a sample value) of the same decoded picture (or slice). That is, intra-prediction means a method of predicting the pixel value of a current processing block with reference to reconstructed regions within a current picture.

Inter prediction means a prediction method deriving a current processing block based on data elements (e.g., sample value or motion vector etc.) other than current picture. That is, the inter prediction means a method predicting a prediction value of the current processing block by referencing reconstructed regions in another picture of another reconstructed picture other than the current picture.

Hereinafter, inter-prediction is described in more detail.

Inter-Prediction (or Inter-Frame Prediction)

Inter-prediction means a prediction method of deriving a current processing block based on the data element (e.g., sample value or motion vector) of a picture other than a current picture. That is, inter-prediction means a method of predicting the pixel value of a current processing block with reference to reconstructed regions within another reconstructed picture other than a current picture.

Inter-prediction (or inter-picture prediction) is a technology for removing redundancy present between pictures and is chiefly performed through motion estimation and motion compensation.

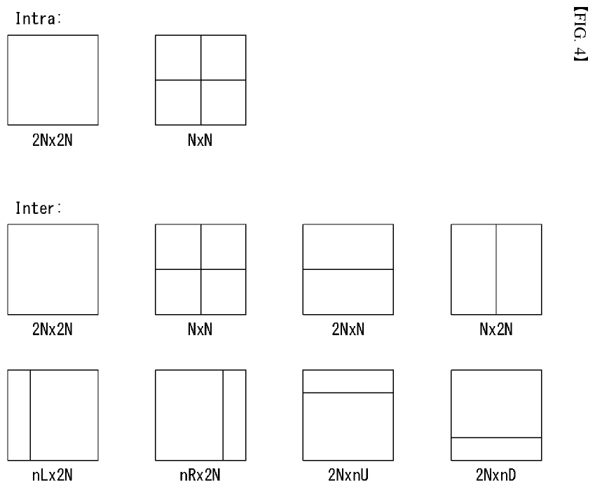

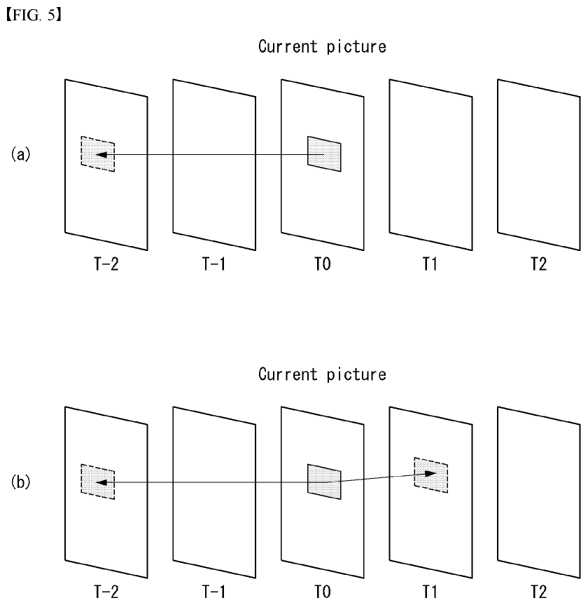

FIG. 5 is an embodiment to which the present disclosure may be applied and is a diagram illustrating the direction of inter-prediction.

Referring to FIG. 5, inter-prediction may be divided into uni-direction prediction in which only one past picture or future picture is used as a reference picture on a time axis with respect to a single block and bi-directional prediction in which both the past and future pictures are referred at the same time.

Furthermore, the uni-direction prediction may be divided into forward direction prediction in which a single reference picture temporally displayed (or output) prior to a current picture is used and backward direction prediction in which a single reference picture temporally displayed (or output) after a current picture is used.

In the inter-prediction process (i.e., uni-direction or bi-directional prediction), a motion parameter (or information) used to specify which reference region (or reference block) is used in predicting a current block includes an inter-prediction mode (in this case, the inter-prediction mode may indicate a reference direction (i.e., uni-direction or bi-direction) and a reference list (i.e., L0, L1 or bi-directional)), a reference index (or reference picture index or reference list index), and motion vector information. The motion vector information may include a motion vector, motion vector predictor (MVP) or a motion vector difference (MVD). The motion vector difference means a difference between a motion vector and a motion vector predictor.

In the uni-direction prediction, a motion parameter for one-side direction is used. That is, one motion parameter may be necessary to specify a reference region (or reference block).

In the bi-directional prediction, a motion parameter for both directions is used. In the bi-directional prediction method, a maximum of two reference regions may be used. The two reference regions may be present in the same reference picture or may be present in different pictures. That is, in the bi-directional prediction method, a maximum of two motion parameters may be used. Two motion vectors may have the same reference picture index or may have different reference picture indices. In this case, the reference pictures may be displayed temporally prior to a current picture or may be displayed (or output) temporally after a current picture.

The encoder performs motion estimation in which a reference region most similar to a current processing block is searched for in reference pictures in an inter-prediction process. Furthermore, the encoder may provide the decoder with a motion parameter for a reference region.

The encoder/decoder may obtain the reference region of a current processing block using a motion parameter. The reference region is present in a reference picture having a reference index. Furthermore, the pixel value or interpolated value of a reference region specified by a motion vector may be used as the predictor of a current processing block. That is, motion compensation in which an image of a current processing block is predicted from a previously decoded picture is performed using motion information.

In order to reduce the transfer rate related to motion vector information, a method of obtaining a motion vector predictor (mvp) using motion information of previously decoded blocks and transmitting only the corresponding difference (mvd) may be used. That is, the decoder calculates the motion vector predictor of a current processing block using motion information of other decoded blocks and obtains a motion vector value for the current processing block using a difference from the encoder. In obtaining the motion vector predictor, the decoder may obtain various motion vector candidate values using motion information of other already decoded blocks, and may obtain one of the various motion vector candidate values as a motion vector predictor.

Reference Picture Set and Reference Picture List

In order to manage multiple reference pictures, a set of previously decoded pictures are stored in the decoded picture buffer (DPB) for the decoding of the remaining pictures.

A reconstructed picture that belongs to reconstructed pictures stored in the DPB and that is used for inter-prediction is called a reference picture. In other words, a reference picture means a picture including a sample that may be used for inter-prediction in the decoding process of a next picture in a decoding sequence.

A reference picture set (RPS) means a set of reference pictures associated with a picture, and includes all of previously associated pictures in the decoding sequence. A reference picture set may be used for the inter-prediction of an associated picture or a picture following a picture in the decoding sequence. That is, reference pictures retained in the decoded picture buffer (DPB) may be called a reference picture set. The encoder may provide the decoder with a sequence parameter set (SPS) (i.e., a syntax structure having a syntax element) or reference picture set information in each slice header.

A reference picture list means a list of reference pictures used for the inter-prediction of a P picture (or slice) or a B picture (or slice). In this case, the reference picture list may be divided into two reference pictures lists, which may be called a reference picture list 0 (or L0) and a reference picture list 1 (or L1). Furthermore, a reference picture belonging to the reference picture list 0 may be called a reference picture 0 (or L0 reference picture), and a reference picture belonging to the reference picture list 1 may be called a reference picture 1 (or L1 reference picture).

In the decoding process of the P picture (or slice), one reference picture list (i.e., the reference picture list 0). In the decoding process of the B picture (or slice), two reference pictures lists (i.e., the reference picture list 0 and the reference picture list 1) may be used. Information for distinguishing between such reference picture lists for each reference picture may be provided to the decoder through reference picture set information. The decoder adds a reference picture to the reference picture list 0 or the reference picture list 1 based on reference picture set information.

In order to identify any one specific reference picture within a reference picture list, a reference picture index (or reference index) is used.

Fractional Sample Interpolation

A sample of a prediction block for an inter-predicted current processing block is obtained from the sample value of a corresponding reference region within a reference picture identified by a reference picture index. In this case, a corresponding reference region within a reference picture indicates the region of a location indicated by the horizontal component and vertical component of a motion vector. Fractional sample interpolation is used to generate a prediction sample for non-integer sample coordinates except a case where a motion vector has an integer value. For example, a motion vector of ¼ scale of the distance between samples may be provided.

In the case of HEVC, fractional sample interpolation of a luma component applies an 8 tab filter in the traverse direction and longitudinal direction. Furthermore, the fractional sample interpolation of a chroma component applies a 4 tab filter in the traverse direction and the longitudinal direction.

FIG. 6 is an embodiment to which the present disclosure may be applied and illustrates integers for ¼ sample interpolation and fraction sample locations.

Referring to FIG. 6, a shadow block in which an upper-case letter (A_ij) is written indicates an integer sample location, and a block not having a shadow in which a lower-case letter (x_i,j) is written indicates a fraction sample location.

A fraction sample is generated by applying an interpolation filter to an integer sample value in the horizontal direction and the vertical direction. For example, in the case of the horizontal direction, the 8 tab filter may be applied to four integer sample values on the left side and four integer sample values on the right side based on a fraction sample to be generated.

Inter-Prediction Mode

In HEVC, in order to reduce the amount of motion information, a merge mode and advanced motion vector prediction (AMVP) may be used.

1) Merge Mode

The merge mode means a method of deriving a motion parameter (or information) from a spatially or temporally neighbor block.

In the merge mode, a set of available candidates includes spatially neighbor candidates, temporal candidates and generated candidates.

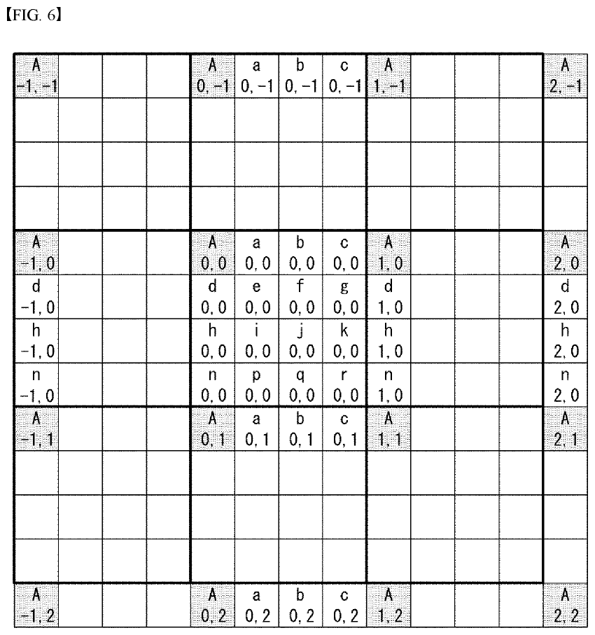

FIG. 7 is an embodiment to which the present disclosure may be applied and illustrates the location of a spatial candidate.

Referring to FIG. 7(a), whether each spatial candidate block is available depending on the sequence of {A1, B1, B0, A0, B2} is determined. In this case, if a candidate block is not encoded in the intra-prediction mode and motion information is present or if a candidate block is located out of a current picture (or slice), the corresponding candidate block cannot be used.

After the validity of a spatial candidate is determined, a spatial merge candidate may be configured by excluding an unnecessary candidate block from the candidate block of a current processing block. For example, if the candidate block of a current prediction block is a first prediction block within the same coding block, candidate blocks having the same motion information other than a corresponding candidate block may be excluded.

When the spatial merge candidate configuration is completed, a temporal merge candidate configuration process is performed in order of {T0, T1}.

In a temporal candidate configuration, if the right bottom block T0 of a collocated block of a reference picture is available, the corresponding block is configured as a temporal merge candidate. The collocated block means a block present in a location corresponding to a current processing block in a selected reference picture. In contrast, if not, a block T1 located at the center of the collocated block is configured as a temporal merge candidate.

A maximum number of merge candidates may be specified in a slice header. If the number of merge candidates is greater than the maximum number, a spatial candidate and temporal candidate having a smaller number than the maximum number are maintained. If not, the number of additional merge candidates (i.e., combined bi-predictive merging candidates) is generated by combining candidates added so far until the number of candidates becomes the maximum number.

The encoder configures a merge candidate list using the above method, and signals candidate block information, selected in a merge candidate list by performing motion estimation, to the decoder as a merge index (e.g., merge_idx[x0][y0]′). FIG. 7(b) illustrates a case where a B1 block has been selected from the merge candidate list. In this case, an “index 1 (Index 1)” may be signaled to the decoder as a merge index.

The decoder configures a merge candidate list like the encoder, and derives motion information about a current prediction block from motion information of a candidate block corresponding to a merge index from the encoder in the merge candidate list. Furthermore, the decoder generates a prediction block for a current processing block based on the derived motion information (i.e., motion compensation).

2) Advanced Motion Vector Prediction (AMVP) Mode

The AMVP mode means a method of deriving a motion vector predictor from a neighbor block. Accordingly, a horizontal and vertical motion vector difference (MVD), a reference index and an inter-prediction mode are signaled to the decoder. Horizontal and vertical motion vector values are calculated using the derived motion vector predictor and a motion vector difference (MVDP) provided by the encoder.

That is, the encoder configures a motion vector predictor candidate list, and signals a motion reference flag (i.e., candidate block information) (e.g., mvp_1×flag[x0][y0]′), selected in motion vector predictor candidate list by performing motion estimation, to the decoder. The decoder configures a motion vector predictor candidate list like the encoder, and derives the motion vector predictor of a current processing block using motion information of a candidate block indicated by a motion reference flag received from the encoder in the motion vector predictor candidate list. Furthermore, the decoder obtains a motion vector value for the current processing block using the derived motion vector predictor and a motion vector difference transmitted by the encoder. Furthermore, the decoder generates a predicted block (i.e., array of predicted samples) for the current processing block based on the derived motion information (i.e., motion compensation).

In the case of the AMVP mode, two spatial motion candidates of the five available candidates in FIG. 7 are selected. The first spatial motion candidate is selected from a {A0, A1} set located on the left side, and the second spatial motion candidate is selected from a {B0, B1, B2} set located at the top. In this case, if the reference index of a neighbor candidate block is not the same as a current prediction block, a motion vector is scaled.

If the number of candidates selected as a result of search for spatial motion candidates is 2, a candidate configuration is terminated. If the number of selected candidates is less than 2, a temporal motion candidate is added.

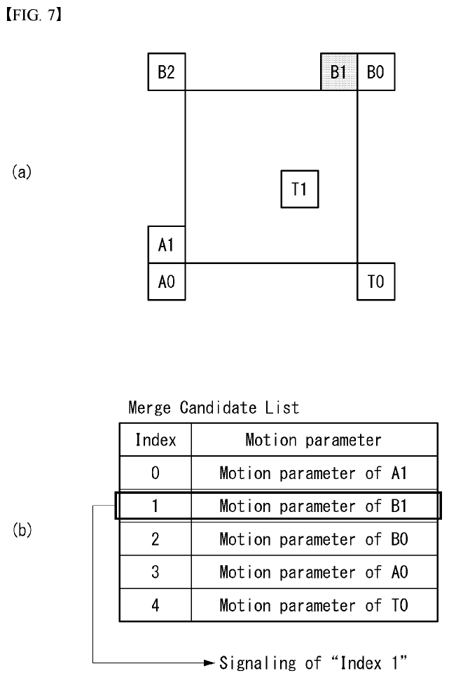

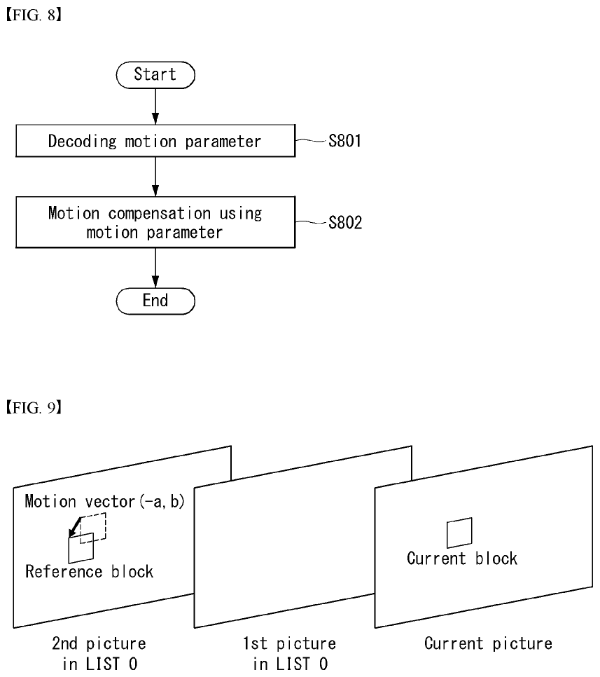

FIG. 8 is an embodiment to which the present disclosure is applied and is a diagram illustrating an inter-prediction method.

Referring to FIG. 8, the decoder (in particular, the inter-prediction unit 261 of the decoder in FIG. 2) decodes a motion parameter for a processing block (e.g., a prediction unit) (S801).

For example, if the merge mode has been applied to the current block, the decoder may decode a merge index signaled by the encoder. Furthermore, the motion parameter of the current processing block may be derived from the motion parameter of a candidate block indicated by the merge index.

Furthermore, if the AMVP mode has been applied to the current block, the decoder may decode a horizontal and vertical motion vector difference (MVD), a reference index and an inter-prediction mode signaled by the encoder. Furthermore, the decoder may derive a motion vector predictor from the motion parameter of a candidate block indicated by a motion vector predictor flag, and may derive the motion vector value of a current block using the motion vector predictor and the received motion vector difference.

The decoder performs motion compensation on the current block using the decoded motion parameter (or information) (S802).

That is, encoder/decoder performs motion compensation predicting an image of a current block from previously decoded picture (i.e., prediction block generation on the current block), by using decoded motion parameter. In other words, encoder/decoder derives a predicted block of the current block from samples of a region corresponding to the current block in previously decoded reference picture.

FIG. 9 is an embodiment to which the present disclosure may be applied and is a diagram illustrating a motion compensation process.

FIG. 9 illustrates a case where a motion parameter for a current block to be encoded in a current picture is uni-direction prediction, a second picture within LIST0, LIST0, and a motion vector (−a, b).

In this case, as in FIG. 9, the current block is predicted using the values (i.e., the sample values of a reference block) of a location (−a, b) spaced apart from the current block in the second picture of LIST0.

In the case of bi-directional prediction, another reference list (e.g., LIST1), a reference index and a motion vector difference are transmitted. The decoder derives two reference blocks and predicts a current block value (i.e., generates a predicted sample of the current block) based on the two reference blocks.

Decoder Side Motion Vector Derivation

In order to reduce a data transmission amount (signaling overhead) related to motion information, the decoder may derive the motion information and use it. That is, in this case, motion-related information is not signaled from the encoder to the decoder.

As described above, the motion-related information of the current block (e.g. coding unit) is not signaled, the method of deriving the motion information of the current block by the decoder may be referred to as various names such as a motion information derivation method, a pattern matched motion vector derivation (PMMVD), a frame rate up conversion (FRUC), or decoder side motion vector derivation (DSMVD). Hereinafter, this method is referred to as a DSMVD method or a DSMVD mode. When the DSMVD mode is applied, the motion information of the current block is not transmitted from the encoder to the decoder, and the decoder directly derives the motion information.

The DSMVD mode may be applied when a merge mode is applied to the current block as a special merge mode. That is, a general merge mode is used when the DSMVD mode is not applied.

When the DSMVD mode is applied, the encoder/decoder may use template matching or bilateral matching in performing motion estimation to find a reference region most similar to the current block. A detailed description on the template matching and the bilateral matching will be described later.

The motion information of the block to which the DSMVD mode is applied is not transmitted from the encoder to the decoder. However, the encoder may transmit information (or flag) indicating whether to apply the DSMVD to the decoder, and when the DSMVD mode is applied to the current block, the encoder may additionally transmit information (i.e. information indicating a motion estimation method used in the encoder) indicating the template matching or the bilateral matching to the decoder.

Specifically, the encoder calculates a rate-distortion cost (RD cost) by applying the template matching and the bilateral matching, respectively, and selects one best method based on the calculated rate-distortion cost. The encoder may transmit information (or flag) indicating the selected best motion estimation method to the decoder.

The decoder acquires (or parses) information (or flag) indicating whether the DSMVD is applied to the current block. When the DSMVD is applied to the current block, the decoder further acquires (or parses) information (or flag) indicating the motion estimation method applied to the current block. The decoder derives the motion information of the current block by using a method indicated by the acquired motion estimation method information. After that, the decoder may generate a prediction block using the derived motion information.

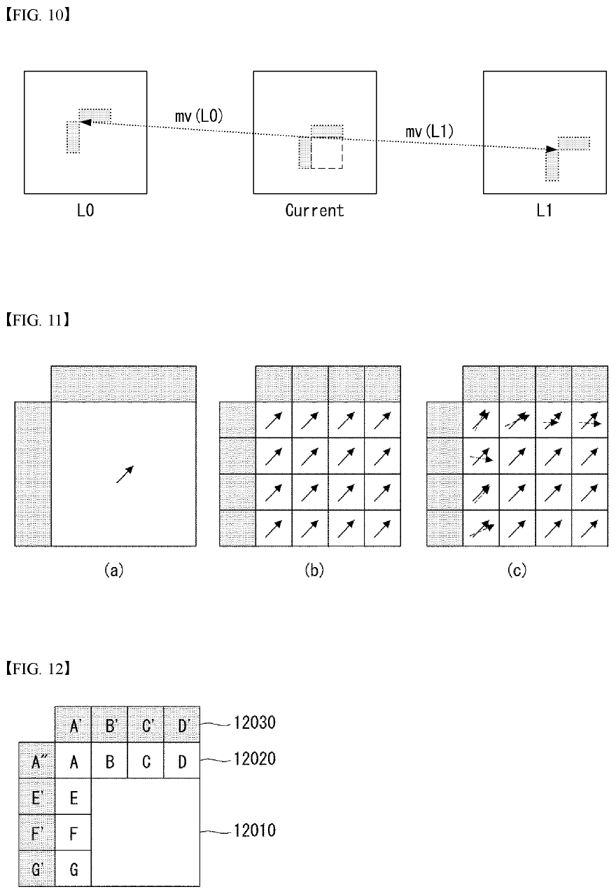

Hereinafter, the template matching among the motion estimation methods used in the DSMVD mode will be described first. The descriptions of FIGS. 10 to 12 relate to the template matching.

FIG. 10 is a diagram for describing template matching according to an embodiment of the present disclosure.

Referring to FIG. 10, the encoder/decoder may derive motion information of the current block by using a neighbor region of the decoded current block as a template.

When the DSVMD mode is applied to the current block and information indicating the motion estimation method indicates the template matching, the decoder derives the motion information of the current block using the template matching.

The template matching is a method (mode) of deriving the motion information of the current block by using information of the neighbor region of the current block that is already decoded (that is, causal). The template matching uses similarity of templates, not the current block.

The template (or template region) indicates a region composed of already decoded neighbor samples around the current block. In addition, a region composed of neighbor samples of a reference block in a reference picture list may be referred to as a template of the reference block. In FIG. 10, gray regions indicate template regions. Hereinafter, unless otherwise stated, the template may mean a template of the current block.

For example, the template may be composed of left-side neighbor blocks and/or upper neighbor blocks (or samples, pixels) of the current block among the decoded regions around the current block. When a size of the current block is N×N, the template may include N upper samples and/or N left-side samples that are adjacent to the current block. Hereinafter, it is described with reference to FIG. 10.

The encoder/decoder may define a neighbor region of the current block as a template, and derive the motion information by finding a region (or closest match) most similar to the template in a reference picture. That is, in the template matching, motion estimation may be performed based on the template region.

FIG. 10 illustrates an example of a mothod that the template matching is performed. In FIG. 10, the figure positioned in the middle shows a current picture, a current block (dotted line region) in the current picture, and a template (shaded region) of the current block. The figures in both sides show regions (or positions) most similar to the template of the current block selected in the reference picture lists L0 and L1, respectively. Two dotted line arrows indicate motion vectors (my (L0) and my (L1)) indicating the selected regions.

The template matching may be performed by a uni-directional prediction or a bi-directional prediction. When the template matching is performed by the bi-directional prediction, two reference pictures selected from each list may be a past picture outputted temporally prior to the current picture, and a future picture outputted temporally later than the current picture, respectively. Alternatively, both the two reference pictures may be the past or future pictures. A detailed process of performing the template matching will be described later.

FIG. 11 illustrates that template matching is performed on subblocks after template matching is performed on a coding block according to an embodiment of the present disclosure.

The template matching may be performed in coding block (or coding unit) units (levels) and in subblock units. The encoder/decoder first performs template matching in coding block units, and then performs the template matching in subblock units.

A subblock is a block in which a coding block is divided into the same size. The subblocks in one coding block all have the same size and shape. For example, when the size of the coding block is M×N, the minimum size of the subblock may be (M/8)×(N/8). In addition, the maximum size of the subblock may be 4×4.

The template matching in subblock units is performed on left-side and upper boundary subblocks (or subblocks that are adjacent to the template) corresponding to some of the subblocks.

FIG. 11(a) illustrates a current block (e.g. a coding unit), a motion vector of the current block (an arrow at the center of the block), and a template (a shaded region) of the current block. FIG. 11(b) illustrates that a current block is divided into 16 subblocks and each subblock has the same motion vector as the motion vector of the current block before the template matching in subblock units is performed.

FIG. 11(c) illustrates that a motion vector is changed by performing template matching on some of the subblocks (subblocks adjacent to the template). In FIG. 11(c), a dotted line arrow indicates the best motion vector of the subblock finally acquired due to the template matching. Reference is made to the description regarding FIG. 12 below with respect to FIG. 11(c).

FIG. 12 illustrates a template and subblocks on which template matching is performed according to an embodiment of the present disclosure.

FIG. 12 is a diagram for better understanding of FIG. 11(c). FIG. 12 illustrates a current block 12010, subblocks 12020 that are adjacent to a template and the template 1230 included in the current block.

The template 1230 includes blocks A′ to G′, and A″ as sub template blocks. Each of the sub template blocks A′ to G′, and A″ constituting the template may have the same size and shape as the subblock of the current block.

The subblocks 12020 that are adjacent to the template are blocks adjacent to the template region among the subblocks of the current block 12010. The subblocks 12020 that are adjacent to the template include subblocks A to G. The subblocks 12020 that are adjacent to the template include upper subblocks B, C, and D, left-side subblocks E, F, and G, and an upper left subblock A. The upper left subblock A may be included in the upper subblocks B, C, and D or the left sub-side subblocks E, F, and G.

As described above in the description of FIG. 11, the template matching in subblock units is performed only on the subblocks 12020, which are adjacent to the template, that are some of the subblocks. In other words, the encoder/decoder performs additional template matching only on subblocks adjacent to the template region. For example, referring to FIG. 12, the template matching may be performed on the blocks A to G. In the process of performing the template matching on the subblocks adjacent to the template, a sub-template block located closest to and adjacent to each subblock may be used.

Hereinafter, referring to FIGS. 10 to 12, it will be described in detail an example of a process in which the encoder/decoder derives the motion information of the current block through the template matching. The following process may be performed in the same manner in the encoder and the decoder.

Template Matching Method

The order of performing the following processes 1) to 8) may be changed in some cases. In addition, the following description is an example of the template matching performed by the bi-directional prediction.

1) First, the encoder/decoder constructs a motion vector (MV) candidate list (or a merge candidate list) by using motion information of a neighbor block. The encoder/decoder uses a general merge mode method in constructing the motion vector candidate list. Details of the merge mode refer to the description of FIG. 7 described above.

After that, the encoder/decoder performs the following processes 2) to 5) on the reference picture list 0 (L0).

2) The encoder/decoder calculates a difference value between a template of a reference block indicated by each motion vector included in the motion vector candidate list and a template of the current block, and selects a motion vector having a minimum difference value.

For example, the encoder/decoder calculates SAD(T(L0, \vec{mv})−T(Cur)) for each of the motion vectors included in the motion vector candidate list, and selects a motion vector having a minimum SAD among them. Here, T(Cur) indicates the template of the current block, and T(L0, \vec{mv}) indicates the template of the reference block indicated by the motion vector my included in the motion vector candidate list. The template of the reference block has the same shape as the template of the current block and is composed of neighbor samples of the reference block. SAD (*) indicates a sum of absolute difference (SAD) value of * region.

For example, referring to FIG. 10, T(Cur) indicates a shaded part of the current picture of FIG. 10, and T(L0, \vec{mv}) indicates a shaded part of the template of the reference block indicated by the motion vector my (L0) in the reference picture list 0 (L0).

That is, the encoder/decoder determines a reference template region most similar to the template of the current block in the reference picture list 0 (L0) based on a difference value between the template regions.

A motion vector having a minimum SAD value selected in L0 may be referred to as a temporary motion vector \vec{MVₜₑₘₚ}. The encoder/decoder may store the temporary motion vector \vec{MVₜₑₘₚ} for a final motion vector calculation.

3) After that, the encoder/decoder performs a local search to determine the best motion vector around a reference block (or an identified position) identified by the temporary motion vector \vec{MVₜₑₘₚ}. That is, the encoder/decoder performs motion estimation based on the temporary motion vector \vec{MVₜₑₘₚ}. The encoder/decoder calculates a difference value between a template of a neighbor position of a position indicated by the temporary motion vector and the template of the current block, and determines a motion vector having a minimum difference value as a final motion vector.

For example, the encoder/decoder calculates SAD T(L0, \vec{MVₜₑₘₚ}+\vec{d})−T(Cur)), and determines the motion vector having the minimum SAD value as the final motion vector \vec{MVₒₚₜ} of the current block \vec{MVₒₚₜ}=\vec{MVₜₑₘₚ}+\vec{dₒₚₜ}.

The arrow shown in FIG. 11(a) shows an example of the final motion vector \vec{MVₒₚₜ} of the current block determined through the processes of 1) to 3) described above.

The processes 2) to 3) described above correspond to a process of performing the template matching in coding block (coding unit) units.

4) After that, the encoder/decoder divides the current block into subblocks according to any rule or predetermined method in order to perform the template matching in subblock units. Details of the subblock refer to the description of FIGS. 11 and 12 described above.

FIG. 11(b) illustrates an example of the subblocks into which the current block is divided. Basically, each subblock has the same motion vector (i.e. \vec{MVₒₚₜ}) as the motion vector of the current block. The motion vector of each subblock may be maintained or changed later.

5) After that, the encoder/decoder performs the template matching on each of some subblocks (left-side subblocks and/or upper subblocks) that are adjacent to the template among the subblocks. The above-described process 3) is performed on each of the subblocks. The encoder/decoder performs a local search to determine the best motion vector of a current subblock around a reference block identified by the final motion vector \vec{MVₒₚₜ}.

For example, the encoder/decoder calculates SAD (T_{sub}(L0, \vec{MVₒₚₜ}+\vec{d})−T_{sub}(Cur)) based on the final motion vector \vec{MVₒₚₜ} for each of the subblocks that are adjacent to the template. Here, T_{sub}(Cur) is a region used for the template matching operation of the subblock, and indicates a region (or block) that is adjacent to the closest position to the current subblock and included in the template T (Cur) of the current block. T_{sub} (Cur) may be referred to as a template of a subblock, a sub-template region, or the like, and has the same size as the subblock. For example, referring to FIG. 12, T_{sub}(Cur) of the subblock A′ corresponds to A′ and/or A″. In addition, T_{sub}(Cur) of the sub block B′ corresponds to B″.

After that, the encoder/decoder determines the motion vector having the minimum SAD value as the final motion vector \vec{MV_{opt,sub}} of the current subblock. The encoder/decoder determines the final motion vector of each of the subblocks in which the template matching can be performed.

In the process of calculating the SAD for each subblock, the block constituting the template while being adjacent to the subblock may be used as a template T_{sub}(Cur) of the subblock. Specifically, when the current subblock is positioned the upper-side of the current block, an upper neighbor block of the corresponding subblock may be used as a template. When the current subblock is positioned to the left-side of the current block, a left-side neighbor block of the corresponding subblock may be used as a template of the current subblock. When the current subblock is positioned to upper left-side of the current block, a left-side or upper-side neighbor block of the corresponding subblock may be used as a template of the current subblock.

For example, referring to FIG. 12, the template T_{sub}(Cur) of the subblock A may be A′ and/or A″. The templates of the subblocks B, C, and D may be B′, C′, and D′, respectively. The templates of the subblocks E, F, and G may be E′, F′, and G′, respectively.

Each subblock may finally have a different motion vector. The subblocks on which the template matching is performed may acquire a finally changed motion vector. The subblocks on which the template matching is not performed have the final motion vector \vec{MVₒₚₜ} of the current block determined in 1) to 3) described above as it is.

In FIG. 11(c), the dotted line arrow indicates the final motion vector of the subblock acquired through the template matching in subblock units. In FIG. 11(c), the subblocks not indicated by the dotted line arrow correspond to blocks on which the template matching in subblock units is not performed, and they have the same motion vector as in FIG. 11 (b).

The encoder/decoder acquires a predictor in L0 based on the final motion vector \vec{MV_{opt,sub}} of each subblock. The predictor determined in L0 may be referred to as an L0 predictor, a P_{L0} or a first predictor.

The processes 4) to 5) described above correspond to processes of performing the template matching in subblock units.

The encoder/decoder acquires the L0 predictor through the processes 2) to 5) described above.

6) After that, the encoder/decoder acquires a predictor in L1 by performing the above-described processes 2) to 5) in the same manner on the reference picture list 1 (L1). The predictor determined in L1 may be referred to as an L1 predictor, a P_{L1} or a second predictor, or the like.

7) After that, the encoder/decoder acquires an average of the L0 predictor and the L1 predictor. The average of the two predictors may be referred to as an average predictor or P_{BI} or the like (P_{BI}=(P_{L0}+P_{L1})/2).

8) After that, the encoder/decoder determines a predictor having a minimum RD cost among the L0 predictor P_{L0}, the L1 predictor P_{L1}, and the average value P_{BI} of the two predictors as the best predictor of the current block based on the rate-distortion cost (RD cost).

The processes 6) to 8) described above are performed when the template matching is performed by the bi-directional prediction.

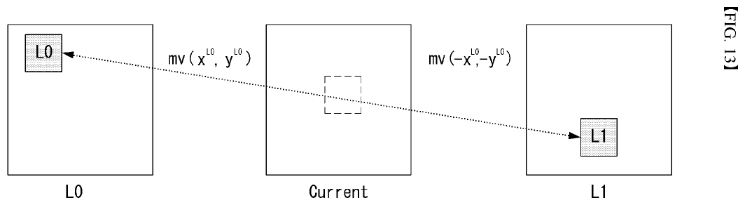

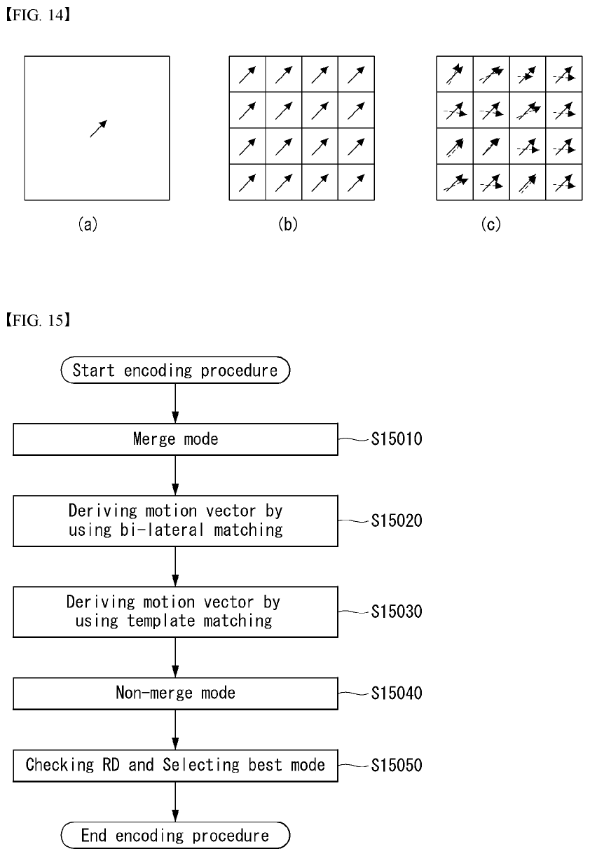

Hereinafter, referring to FIG. 13 and FIG. 14, a bi-lateral matching, which is one of motion estimation methods used in DSMVD, will be described.

FIGS. 13 and 14 are diagrams for describing a bi-lateral matching according to an embodiment of the present disclosure.

Referring to FIG. 13 and FIG. 14, the encoder/decoder may derive motion information of a current block based on similarity between blocks indicated by two vectors that are symmetric to each other.

The bi-lateral matching method is a method of determining a motion vector having a minimum difference between two prediction blocks generated by using two symmetric motion vectors as a motion vector of the current block. Specifically, the bi-lateral method is a method of finding a block having a minimum matching error between two reference blocks included in two different reference pictures, respectively, according to a motion trajectory of the current block. Assuming a continuous motion trajectory, a first motion vector and a second motion vector may be determined in proportion to an interframe distance between a current picture and a reference picture. The bi-lateral matching may be performed with bi-directional prediction.

Referring to FIG. 13, the encoder/decoder calculates a difference value between a reference block indicated by the first motion vector mv(x^{L0}, y^{L0}) and a reference block indicated by the second motion vector mv(−x^{L0}, −y^{L0}). The first motion vector is symmetrical with the second motion vector. The encoder/decoder determines a motion vector having a minimum difference value as the motion vector of the current block.

Hereinafter, referring to FIGS. 13 and 14, it will be described in detail an example of a process in which the encoder/decoder derives the motion information of the current block through the bi-lateral matching. The following process may be performed in the same manner in the encoder and the decoder.

Bilateral Matching Method

The order of performing the following processes 1) to 5) may be changed in some cases.

1) First, the encoder/decoder constructs a motion vector (MV) candidate list (or a merge candidate list) by using motion information (a motion vector) of a neighbor block. The encoder/decoder uses a general merge mode in constructing the motion vector candidate list. Details of the merge mode refer to the description of FIG. 7 described above.

2) After that, for each motion vector included in the motion vector candidate list, the encoder/decoder calculates a difference value between a first prediction block based on the first motion vector included in the list and a second prediction block based on the second motion vector symmetric to the first motion vector for each of the motion vectors included in the list. The encoder/decoder selects a motion vector having a minimum difference value.

For example, the encoder/decoder calculates SAD(P(L0, \vec{mv})−P(L1, −\vec{mv})) for each of the motion vectors included in the motion vector candidate list, and selects a motion vector having a minimum SAD. Here, P(L0, \vec{mv}) indicates a predictor of list L0 indicated by the motion vector my. P(L1, −\vec{mv}) indicates a predictor of list L1 indicated by the motion vector −mv. SAD (*) indicates a sum of absolute difference (SAD) value of * region.

The motion vector having the minimum SAD value may be referred to as a temporary motion vector \vec{MVₜₑₘₚ}. The encoder/decoder may store the temporary motion vector \vec{MVₜₑₘₚ} for a final motion vector calculation.

3) The encoder/decoder performs a local search to determine the best motion vector of the current block around a reference block (or a position) identified by the temporary motion vector \vec{MVₜₑₘₚ}. That is, the encoder/decoder performs motion estimation based on the temporary motion vector \vec{MVₜₑₘₚ}.

For example, the encoder/decoder calculates SAD (P(L0, \vec{MVₜₑₘₚ}+\vec{d})−P(L1, −\vec{MVₜₑₘₚ}−\vec{d}), and determines the motion vector having the minimum SAD value as a final motion vector \vec{MVₒₚₜ} of the current block (\vec{MVₒₚₜ}=\vec{MVₜₑₘₚ}+\vec{dₒₚₜ}). The arrow shown in FIG. 14(a) shows an example of the final motion vector \vec{MVₒₚₜ} of the current block determined through the processes of 1) to 3) described above.

4) After that, the decoder divides the current block into subblocks according to any rule or predetermined method. Details of the subblock refer to the description of FIGS. 11 and 12 described above.

For example, FIG. 14(b) illustrates that the current block (FIG. 14(a)) is divided into 16 subblocks. Basically, each subblock has the same motion vector (i.e. \vec{MVₒₚₜ}) as the motion vector of the current block. The motion vector of each subblock may be maintained or changed later.

5) The encoder/decoder performs a local search to determine the final motion vector of each subblock based on the final motion vector \vec{MVₒₚₜ} of the current block. That is, the encoder/decoder performs the process 3) described above for each subblock. Unlike the template matching, the bi-lateral matching is performed in process 3) for all subblocks.

For example, the decoder calculates SAD(P_{sub}(L0, \vec{MVₜₑₘₚ}+\vec{d})−P_{sub}(L1, −\vec{MVₜₑₘₚ}−\vec{d}) based on the final motion vector \vec{MVₒₚₜ} for each of the subblocks. The encoder/decoder determines the motion vector having the minimum SAD value as the final motion vector \vec{MV_{opt,sub-CU}} of the subblock. The dotted line arrow shown in FIG. 14(c) shows an example of the final motion vector \vec{MV_{opt,sub-CU}} of each subblock. That is, each subblock may finally acquire a different motion vector.

The encoder/decoder determines a predictor acquired based on the final motion vector \vec{MV_{opt,sub-CU}} of each subblock as the best predictor of the current block.

FIG. 15 illustrates a flowchart of an encoding procedure according to an embodiment of the present disclosure.

Referring to FIG. 15, an encoder may determine the best mode of one of a merge mode, a non-merge mode, template matching, and bi-lateral matching.

The encoder applies the merge mode to a current block (S15010). Details of the merge mode refer to the description of FIG. 7 described above.

After that, the encoder derives motion information of the current block by using the bi-lateral matching (S15020). Details of a bi-lateral mode refer to the description of FIGS. 13 and 14 described above.

After that, the encoder derives the motion information of the current block by using the template matching (S15030). Details of the template matching refer to the description of FIGS. 10 to 12 described above.

After that, the encoder applies the non-merge mode to the current block (S15040). The non-merge mode may be an AMVP mode. Details of the AMVP mode refer to the description of FIG. 7 described above.

The encoder performs all four modes described above, and selects the best mode based on the rate-distortion (RD) cost (S15050). The encoder transmits information indicating the selected mode to the decoder.

The order of performing the above-described steps S15010 to S15050 may be changed. The encoder may perform each mode in an order different from that shown in FIG. 14, and select one mode having a minimum RD cost.

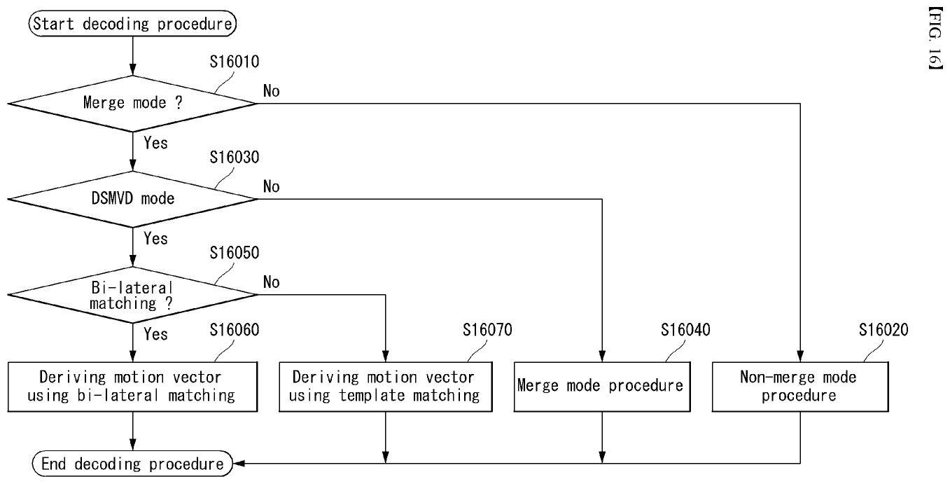

FIG. 16 illustrates a flowchart of a decoding procedure according to an embodiment of the present disclosure.

Referring to FIG. 16, a decoder may acquire motion information and decode an image by using one of a merge mode, a non-merge mode, template matching, and bi-lateral matching. The following procedure may be performed in units of the coding units.

The decoder checks (or determines) whether a mode applied to an inter prediction of a current block (or a current coding unit) is the merge mode (S16010). The decoder acquires (parses) information (flag) indicating whether a mode applied to the current block transmitted from an encoder is the merge mode or the non-merge mode. For example, the information may be referred to as a merge flag (‘merge_flag’). In the merge mode, the decoder generates a prediction block based on a merge candidate, a merge index, a reference picture index (inter_pre_didc), and the like transmitted from the encoder.

If the inter prediction mode of the current block is not the merge mode, the decoder performs decoding based on the non-merge mode (S16020). That is, when the flag parsed in step S16010 does not indicate the merge mode, the decoder performs decoding using the non-merge mode procedure. The non-merge mode may be an AMVP mode.

If the inter prediction mode of the current block is the merge mode, the decoder checks whether a DSMVD mode is applied to the current block (S16030). That is, when the flag parsed in step S16010 indicates the merge mode, the decoder additionally checks whether a mode used for prediction is the DSMVD mode. To this end, the decoder additionally parses (acquires) information (flag) indicating whether the DSMVD mode is applied. For example, the flag may be referred to as ‘fruc_merge_flag’ or ‘dsmvd_merge_flag’. If the ‘fruc_merge_flag’ is 1, it may indicate that the DSMVD mode is applied to the current block, and if it is 0, it may indicate that the DSMVD mode is not applied to the current block.

If the flag parsed in step S16030 indicates that the DSMVD mode is not applied to the current block, the decoder performs decoding based on the existing merge mode procedure (S16040). Details of the AMVP mode and the merge mode refer to the description of FIG. 7 described above.

If the flag parsed in step S16030 indicates that the DSMVD mode is applied to the current block, the decoder checks (determines) whether a mode applied to the current block is the bi-lateral matching mode or the template matching (S16050). The decoder parses a flag indicating whether the mode applied to the current block is the bi-lateral matching or the template matching. For example, the flag may be referred to as ‘fruc_merge_mode’ or ‘dsmvd_merge_mode’. If the ‘fruc_merge_mode’ is 1, it may indicate that the bi-lateral matching is applied to the current block, and if it is 0, it may indicate that the template matching is applied to the current block.

If the flag parsed in step S16050 indicates the bi-lateral matching, the decoder derives motion information of the current block using the bi-lateral matching (S16060). Details of the bi-lateral matching refer to the description of FIG. 13 described above.

If the flag parsed in step S16050 indicates the template matching, the decoder derives the motion information of the current block using the template matching (S16070). Details of the template matching refer to the description of FIGS. 10 to 12 described above.

Table 1 below shows an example of a part of syntax of a coding unit level for the DSMVD mode proposed in the present disclosure. The following syntax may be identically performed in encoding/decoding process of the encoder and the decoder. Hereinafter, the description will be based on the decoder.

TABLE 1

| coding_unit | Descriptor |
|---|---|
| if (slice_type !=I) { | |
| cu_skip_flag | ae (v) |
| if (cu_skip_flag) { | |
| fruc_merge_flag | ae (v) |
| if (fruc_merge_flag) { | |
| fruc_merge_mode | ae (v) |
| else { | |
| if (MaxNumMergeCand >1) { | |
| merge_idx | ae (v) |
| } | |
| } | |
| } | |
| else { | |
| merge_flag | ae (v) |
| if (merge_flag) { | |
| fruc_merge_flag | ae (v) |
| if (fruc_merge_flag) { | |
| fruc_merge_mode | ae (v) |
| else { | |
| if (MaxNumMergeCand >1) { | |
| merge_idx | ae (v) |
| } | |
| } | |
| } else { | |
| ... | |
| } | |
| } | |
| } | |
| } | |

Referring to Table 1, a decoding process for a coding unit (or coding block) will be described.
if(slice_type!=I): If the decoding process ‘coding unit’ for the coding unit (or coding block) is called, the decoder determines whether a slice type of the current coding unit is an I slice type.
cu_skip_flag: If the slice type of the current coding unit is not the I slice (i.e. if it is P or B slice), the decoder parses ‘cu_skip_flag’. Here, the ‘cu_skip_flag’ may indicate whether the current coding unit is a skip mode. If the ‘cu_skip_flag’ is 1, it may indicate that the current coding unit is the skip mode.
if(cu_skip_flag): The decoder determines whether the current coding unit is the skip mode.
fruc_merge_flag: If the current coding unit is the skip mode, the decoder parses the ‘fruc_merge_flag’. The ‘fruc_merge_flag’ may indicate whether the DSMVD mode is applied to the current coding unit. The ‘fruc_merge_flag’ may also be expressed as the ‘dsmvd_merge_flag’.
if(fruc_merge_flag): The decoder determines whether the DSMVD mode is applied to the current coding unit. If the ‘fruc_merge_flag’ is 1, it may indicate that the DSMVD mode is applied to the current coding unit.
fruc_merge_mode: If the DSMVD mode is applied to the current coding unit, the decoder parses the ‘fruc_merge_mode’. The ‘fruc_merge_mode’ may indicate whether the current coding unit is the template matching mode or the bi-lateral matching mode. For example, if the ‘fruc_merge_mode’ is 1, it may indicate the template matching mode, and if it is 0, it may indicate the bi-lateral matching mode.
merge_idx: The decoder parses ‘merge_idx’ if the DSMVD mode is not applied to the current coding unit. The ‘merge_idx’ may indicate the merge index.
merge_flag: On the other hand, if the current coding unit is not the skip mode (if the ‘cu_skip_flag’ is 0), the decoder parses the ‘merge_flag’. The ‘merge_flag’ may indicate whether the current coding unit is the merge mode. If the ‘merge_flag’ is 1, it may indicate that the merge mode is applied to the current coding unit.
if(merge_flag): After that, the decoder parses the fruc_merge_flag if the current coding unit is the merge mode.
fruc_merge_mode: The decoder parses the fruc_merge_mode if the fruc_merge_flag indicates that the DSMVD mode is applied to the current coding unit. The ‘fruc_merge_mode’ may indicate whether the current coding unit is the template matching mode or the bi-lateral matching mode.
merge_idx: The decoder parses the merge_idx if the fruc_merge_flag indicates that the DSMVD mode is not applied to the current coding unit.

In the template matching, performing the template matching in subblock units may rather lower coding efficiency or increase complexity of the encoder/decoder in some cases. Hereinafter, it is proposed a method of reducing complexity of encoding/decoding and improving compression efficiency and coding performance by skipping a template matching procedure of a subblock level.

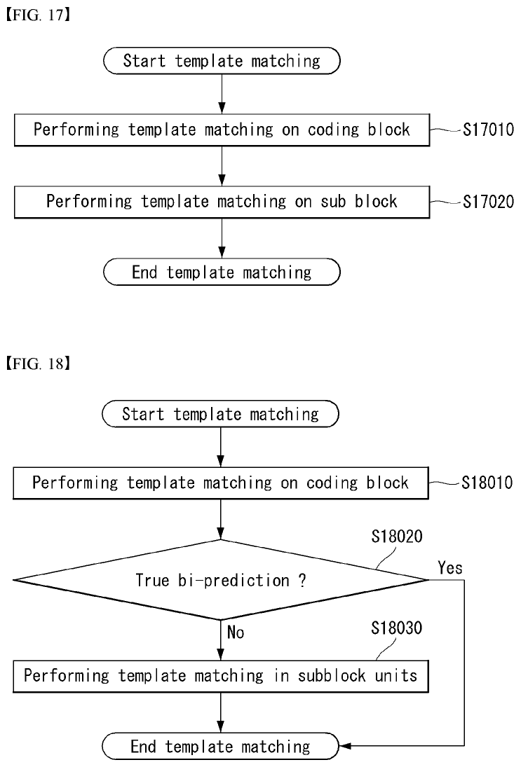

FIG. 17 illustrates a flowchart of processes of performing template matching on a coding block and a subblock according to an embodiment of the present disclosure.

FIG. 17 illustrates a flowchart in a case in which template matching in subblock units is always performed.

First, an encoder/decoder performs template matching on a coding block (or coding unit) (S17010). After that, the encoder/decoder performs the template matching on a subblock (or sub-coding unit) (S17020). That is, the template matching is first performed in coding block units, and then in subblock units. Details of how the template matching is performed on the coding block and the subblock refer to the description of FIGS. 10 to 12 described above.

The encoder/decoder may not perform the template matching in subblock units to improve coding performance in a specific case. Hereinafter, it will be described a case in which the encoder/decoder skips the template matching in subblock units.

FIG. 18 illustrates a flowchart of processes of selectively performing template matching in subblock units according to an embodiment of the present disclosure.

### Embodiment 1

According to the present embodiment, an encoder/decoder may determine whether to skip template matching in subblock units according to whether a current block (or a current coding block) is true bi-prediction.

First, the decoder performs the template matching on the current coding block (S18010). This step may be performed in the same manner as or similar manner to step S17010 of FIG. 17 described above.

After that, the decoder determines (or judges) whether the current coding block is the true bi-prediction (S18020). In step S18020, the decoder checks whether the current coding block is the true bi-prediction and performs an operation for this. If the current coding block is the true bi-prediction, the decoder does not perform the template matching in subblock units and ends the template matching procedure.

If the current coding block is not the true bi-prediction, the decoder performs the template matching in subblock units (S18030). This step may be performed in the same manner as or similar manner to step S17020 of FIG. 17 described above.

The true bi-prediction refers to a case in which directions of L0 predictor my (L0) generated based on a reference picture list 0 and L1 predictor my (L1) generated based on a reference picture list 1 are opposite directions with respect to the current block in bi-directional prediction. Here, the opposite directions do not necessarily mean symmetry. In other words, the true bi-prediction may also be understood as a case where two reference pictures selected by the bi-directional prediction are a picture (past picture) outputted temporally prior to a current picture, and a picture (future picture) outputted temporally later than the current picture, respectively.

For example, if the current picture is a picture having POC 3 and a reference picture of L0 is a picture having POC 2 and a reference picture of L1 is a picture having POC 5, this means that the current coding block corresponds to the true bi-prediction.

Specifically, when a motion vector prediction value determined in L0 and a motion vector prediction value determined in L1 are determined using the past picture and the future picture, respectively, the decoder does not perform the template matching in subblock units. In other words, when both the motion vector prediction value determined in L0 and the motion vector prediction value determined in L1 are determined using only the past picture or using only the future picture, the decoder performs the template matching in subblock units.

Whether it is the true bi-prediction may be determined in block units. The encoder/decoder may perform operations for checking whether it is the true bi-prediction in block units.

Unlike the order disclosed in FIG. 18, step S18020 may be performed before step S18010. That is, before the template matching is performed on the coding block, whether the current block satisfies conditions may be determined first.

The encoder may perform the template matching using the above-described procedures S18010 to S18030 similarly to the decoder.

In the case of the true bi-predition, the motion of a block is generally not large. Therefore, in this case, the encoder/decoder can acquire sufficient encoding/decoding performance only by the template matching in coding block units. In addition, in most cases since the bi-lateral matching is considered, the template matching in subblock units may increase the complexity of the encoding/decoding procedure.

Therefore, according to the present embodiment, when the current coding block is the true bi-predition, the encoder/decoder may improve coding performance by skipping the template matching in subblock units.

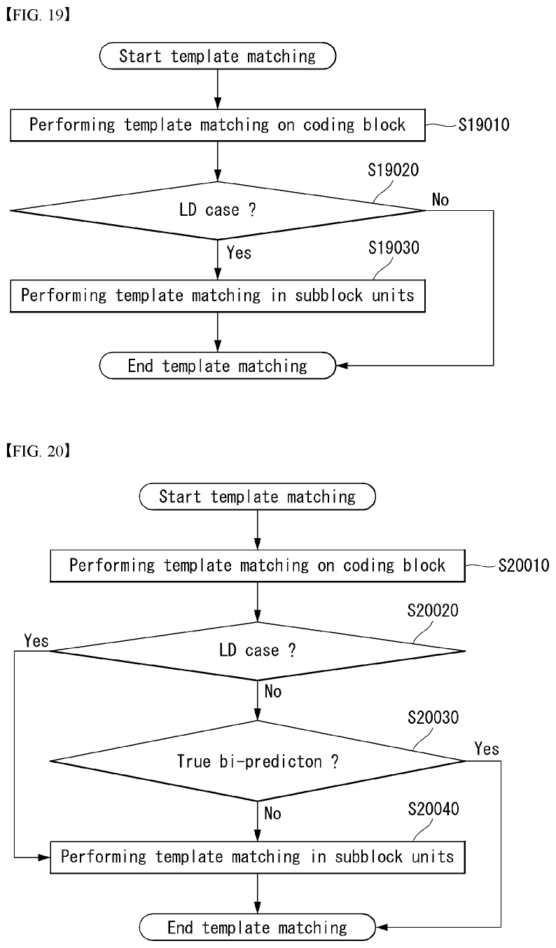

FIG. 19 illustrates a flowchart of processes of selectively performing template matching in subblock units according to another embodiment of the present disclosure.

### Embodiment 2

According to the present embodiment, an encoder/decoder may determine whether to skip template matching in subblock units according to whether a current coding block is a low delay case.

Referring to FIG. 19, when the current coding block (or current block) is not the low delay case (LD case), the encoder/decoder may skip the template matching in subblock units.

First, the decoder performs the template matching on the current coding block (S19010). This step may be performed in the same manner as or similar manner to step S17010 of FIG. 17 described above.

After that, the decoder checks whether the current coding block is the LD case (S19020). This process may be referred to as low delay check (LDC). In step S19020, if the current coding block is not the LD case, the decoder does not perform the template matching in subblock units and ends the template matching procedure after performing the template matching in coding block units.

If the current coding block is the LD case, the decoder performs the template matching in subblock units (S19030). This step may be performed in the same manner as or similar manner to step S17020 of FIG. 17 described above.

The LD case means that all reference pictures of the current block are past pictures outputted prior to a current picture on the basis of the time axis of the current block. For example, if the current picture is a picture having POC 3 and the reference picture is a picture having POC 2 and a picture having POC 1, this corresponds to a case where the current block is the LD case.

Since information about the reference picture may be transmitted in picture or slice units, the encoder/decoder may determine whether it is the LD case in picture or slice units. Information indicating whether it is the LD case may be transmitted in picture or slice units. However, the LDC process (step S19020) for checking whether the coding block is the LD case may be performed in block units.

The encoder may perform the template matching using the same procedure as the above-described procedures S19010 to S19030.

Whether it is the LD case may be determined in slice or picture units. Therefore, according to the present embodiment, if the current coding block is not the LD case, the encoder/decoder may reduce computational complexity of encoding/decoding by skipping the template matching in subblock units.

FIG. 20 is a flowchart of processes of selectively performing template matching on a subblock after template matching is performed on a coding block according to another embodiment of the present disclosure.

### Embodiment 3

According to the present embodiment, the encoder/decoder may determine whether to skip the template matching in subblock units in consideration of whether the current coding block is the LD case and the true bi-prediction.

First, the decoder performs the template matching on the current coding block (S20010). This step may be performed in the same manner as or similar manner to step S17010 of FIG. 17 described above.

After that, the decoder checks whether the current coding block is the LD case (S20020). This step may be performed in the same manner as or similar manner to step S19020 of FIG. 19.

If the current coding block is the LD case, the decoder performs the template matching in subblock units without determining whether the current coding block is the true bi-prediction.

If the current coding block is not the LD case, the decoder checks whether the current coding block is the true bi-predicton (520030). This step may be performed in the same manner as or similar manner to step S18020 of FIG. 18 described above.

If the current coding block is not the LD case and is not the true bi-predicton, the decoder performs the template matching in subblock units.

If the current coding block is not the LD case but is the true bi-prediction, the decoder does not perform the template matching in subblock units, and ends the template matching.

That is, if the current coding block is the LD case, or if it is not the LD case but the true bi-prediction, the decoder performs the template matching in subblock units (S20040). This step may be performed in the same manner as or similar manner to step S17020 of FIG. 17 described above.

The encoder may perform the template matching using the above-described procedures S20010 to S20040.

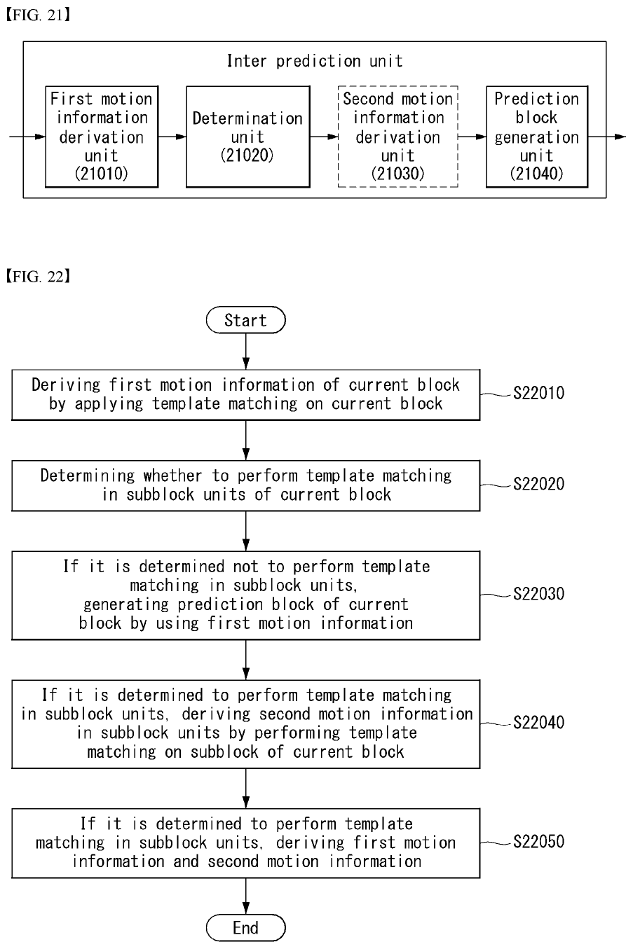

FIG. 21 is a block diagram of an inter prediction unit according to an embodiment of the present disclosure.

The encoder/decoder includes an inter prediction unit that performs temporal prediction and/or spatial prediction to remove temporal redundancy and/or spatial redundancy with reference to a reconstructed picture.

The inter prediction unit includes a first motion information derivation unit 21010, a determination unit 21020, a second motion information derivation unit 21030, and a prediction block generation unit 21040. The first motion information derivation unit 21010 and the second motion information derivation unit 21030 may be implemented as one motion information derivation unit. The inter prediction unit may be implemented in the encoder of FIG. 1 and/or the decoder of FIG. 2.

The first motion information derivation unit 21010 derives first motion information of a current block by applying template matching on the current block (current coding block). The first motion information is motion information in coding block units.

The determination unit 21020 determines whether to perform the template matching in subblock units of the current block

The second motion information derivation unit 21030 derives second motion information in subblock units by performing the template matching on a subblock of the current block if it is determined to perform the template matching in the subblock units

The prediction block generation unit 21040 generates a prediction block of the current block by using the first motion information if it is determined not to perform the template matching in subblock units. In addition, the prediction block generation unit 21040 generates a prediction block of the current block by using the first motion information and the second motion information if it is determined to perform the template matching in subblock units.

A neighbor template region of the current block comprises upper neighbor samples of the current block and/or left-side neighbor samples of the current block. A neighbor template region of a reference block comprises upper neighbor samples of the reference block and/or left-side neighbor samples of the reference block.

According to an embodiment, the determination unit 21020, if a first predictor which is generated by performing an inter prediction based on a reference picture included in a reference picture list 0 and a second predictor which is generated by performing an inter prediction based on a reference picture included in a reference picture list 1 are both generated by using only reference pictures outputted temporally prior to a current picture, may determine to perform the template matching. In addition, the determination unit 21020, if they are both generated by using only reference pictures outputted temporally later than the current picture, may determine to perform the template matching in subblock units. That is, when it is not the true bi-prediction, the determination unit 21020 may determine to perform the template matching in subblock units.

In addition, according to an embodiment, the determination unit 21020, if each of a first predictor which is generated by performing an inter prediction based on a reference picture included in a reference picture list 0 and a second predictor which is generated by performing an inter prediction based on a reference picture included in a reference picture list 1 is generated by using a reference picture outputted temporally prior to a current picture and a reference picture outputted temporally later than the current picture, may determine to not to perform the template matching in subblock units. That is, when it is the true bi-prediction, the determination unit 21020 may determine to skip the template matching in subblock units.

In addition, according to an embodiment, the determination unit 21020, if a reference picture list of the current block only includes reference pictures outputted temporally prior to a current picture (i.e. if it is the LD case), may determine to perform the template matching in subblock units.

In addition, according to an embodiment, the determination unit 21020, if a reference picture of the current block included in a reference picture list includes only a reference picture outputted temporally later than a current picture, or includes both a reference picture outputted temporally prior to the current picture and a reference picture outputted temporally later than the current picture (i.e. if it is not the LD case), may determine to skip the template matching in the subblock units.

In addition, according to an embodiment, the determination unit 21020, if the current block is the LD case, may determine to perform the template matching in subblock units. However, if the current block is not the LD case and the current block is the true bi-prediction, the determination unit 21020 may determine to skip the template matching in subblock units, and if the current block is not the true bi-prediction, the determination unit 21020 may determine to perform the template matching in subblock units.

In addition, according to an embodiment, the second motion information derivation unit 21030 partitions the current block into a plurality of subblocks having the same size, and acquires the first motion information in the current block units as temporary motion information of the plurality of subblocks. After that, the second motion information derivation unit 21030 may derive the second motion information by applying the template matching in subblock units based on the first motion information. The second motion information corresponds to motion information in subblock units.

In addition, according to an embodiment, the second motion information derivation unit 21030 may derive motion information which minimizes a difference value between a neighbor template region of the left-side subblocks and/or a neighbor template region of the upper subblocks and, a neighbor template region of adjacent region of a reference block identified by the first motion information as a final motion information of the subblock.

In addition, according to an embodiment, the first motion information derivation unit 21010 may construct a motion vector candidate list based on motion information of a decoded neighbor block of the current block, and acquire a difference value between a neighbor template region of a reference block indicated by a motion vector included in the motion vector candidate list on each of motion vectors included in the motion vector candidate list and the neighbor template region of the current block. After that, the first motion information derivation unit 21010 may determine a motion vector having a minimum difference value among the motion vectors included in the motion vector candidate list as a temporary motion vector, and determine a motion vector minimizing a difference value between a neighbor template region of adjacent region of a reference block identified by the temporary motion vector and the neighbor template region of the current block as the first motion information.

In addition, according to an embodiment, the decoder may identify whether an inter prediction mode of the current block is a merge mode which is a mode deriving motion information of the current block using spatially or temporally neighboring block of the current block, and if the inter prediction mode of the current block is the merge mode, may identify whether a DSMVD mode is applied to the current block. If the DSMVD mode is applied to the current block, the decoder may identify whether the template matching is applied to the current block.

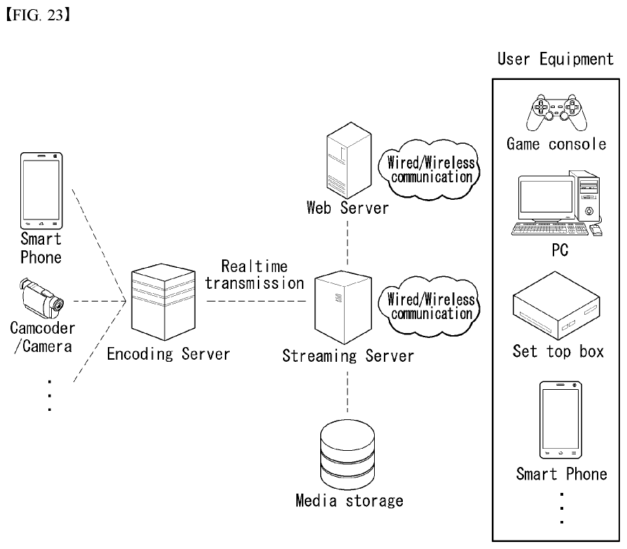

FIG. 22 is a flowchart of an image decoding method based on an inter prediction according to an embodiment of the present disclosure.

A decoder derives first motion information of a current block by applying template matching on the current block (S22010). The template matching is a mode deriving motion information minimizing a difference value between a neighbor template region of the current block and a neighbor template region of a reference block of a reference picture.

After that, the decoder determines whether to perform the template matching in subblock units of the current block (S22020).

After that, if it is determined not to perform the template matching in subblock units, the decoder generates a prediction block of the current block by using the first motion information (S22030).

After that, if it is determined to perform the template matching in subblock units, the decoder derives second motion information in subblock units by performing the template matching on a subblock of the current block (S22040).

After that, if it is determined to perform the template matching in subblock units, the decoder generates a prediction block of the current block by using the first motion information and the second motion information (S22050).

A detailed method of performing the template matching in current block and subblock units refers to the description of FIGS. 10 to 12 described above.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

### INDUSTRIAL APPLICABILITY

Hereinabove, the preferred embodiments of the present disclosure are disclosed for an illustrative purpose and hereinafter, modifications, changes, substitutions, or additions of various other embodiments will be made within the technical spirit and the technical scope of the present disclosure disclosed in the appended claims by those skilled in the art.

1. An image decoding method based on an inter prediction, comprising:
deriving first motion information of a current block by applying template matching on the current block, wherein the template matching is a mode deriving motion information minimizing a difference value between a neighbor template region of the current block and a neighbor template region of a reference block of a reference picture;
determining whether to perform the template matching in subblock units of the current block;
if it is determined not to perform the template matching in the subblock units, generating a prediction block of the current block by using the first motion information;
if it is determined to perform the template matching in the subblock units, deriving second motion information in subblock units by performing the template matching on a subblock of the current block; and
if it is determined to perform the template matching in the subblock units, generating a prediction block of the current block by using the first motion information and the second motion information.

2. The image decoding method of claim 1,
wherein the neighbor template region of the current block comprises upper neighbor samples of the current block and/or left-side neighbor samples of the current block, and
wherein the neighbor template region of the reference block comprises upper neighbor samples of the reference block and/or left-side neighbor samples of the reference block.

3. The image decoding method of claim 1,
wherein, when determining whether to perform the template matching in subblock units of the current block,
it is determined to perform the template matching in the subblock units if a first predictor which is generated by performing an inter prediction based on a reference picture included in a reference picture list 0 and a second predictor which is generated by performing an inter prediction based on a reference picture included in a reference picture list 1 are both generated by using only reference pictures outputted temporally prior to a current picture, or both generated by using only reference pictures outputted temporally later than the current picture.

4. The image decoding method of claim 1,
is wherein, when determining whether to perform the template matching in subblock units of the current block,
it is determined not to perform the template matching in the subblock units if each of a first predictor which is generated by performing an inter prediction based on a reference picture included in a reference picture list 0 and a second predictor which is generated by performing an inter prediction based on a reference picture included in a reference picture list 1 is generated by using a reference picture outputted temporally prior to a current picture and a reference picture outputted temporally later than the current picture.

5. The image decoding method of claim 1,
wherein, when determining whether to perform the template matching in subblock units of the current block,
it is determined to perform the template matching in the subblock units if a reference picture list of the current block only includes reference pictures outputted temporally prior to a current picture.

6. The image decoding method of claim 1,
wherein, when determining whether to perform the template matching in subblock units of the current block,
it is determined not to perform the template matching in the subblock units if a reference picture of the current block included in a reference picture list includes only a reference picture outputted temporally later than a current picture, or includes both a reference picture outputted temporally prior to the current picture and a reference picture outputted temporally later than the current picture.

7. The image decoding method of claim 1,
wherein, when determining whether to perform the template matching in subblock units of the current block,
it is determined to perform the template matching in the subblock units if a reference picture list of the current block includes only reference pictures outputted temporally prior to a current picture,
wherein, when the reference picture list of the current block includes only reference pictures outputted temporally later than the current picture or includes both a reference picture outputted temporally prior to the current picture and a reference picture outputted temporally later than the current picture,
it is determined not to perform the template matching in the subblock units if a first predictor which is generated by performing an inter prediction based on a reference picture included in a reference picture list 0 and a second predictor which is generated by performing an inter prediction based on a reference picture included in a reference picture list 1 are generated by using a reference picture outputted temporally prior to the current picture and a reference picture outputted temporally later than the current picture, and
it is determined to perform the template matching in the subblock units if the first predictor and the second predictor are both generated by using only reference pictures outputted temporally prior to the current picture, or both generated by using only reference pictures outputted temporally later than the current picture.

8. The image decoding method of claim 1,
wherein the deriving the second motion information in subblock units further comprises:
partitioning the current block into a plurality of subblocks having the same size;
acquiring the first motion information as temporary motion information of the plurality of subblocks; and
deriving the second motion information by applying the template matching in subblock units based on the first motion information,
wherein the template matching is applied on each of left-side subblocks and/or upper subblocks that are adjacent to the neighbor template region of the current block among the plurality of subblocks.

9. The image decoding method of claim 8,
wherein, when deriving the second motion information by applying the template matching in subblock units based on the first motion information, motion information which minimizes a difference value between a neighbor template region of the left-side subblocks and/or a neighbor template region of the upper subblocks and, a neighbor template region of adjacent region of a reference block identified by the first motion information is derived as a final motion information of the subblock.

10. The image decoding method of claim 1,
wherein the deriving first motion information of a current block by applying template matching on the current block further comprises:
constructing a motion vector candidate list based on motion information of a decoded neighbor block of the current block;
acquiring a difference value between a neighbor template region of a reference block indicated by a motion vector included in the motion vector candidate list on each of motion vectors included in the motion vector candidate list and the neighbor template region of the current block;
determining a motion vector having a minimum difference value among the motion vectors included in the motion vector candidate list as a temporary motion vector; and
determining a motion vector minimizing a difference value a difference value between a neighbor template region of adjacent region of a reference block identified by the temporary motion vector and the neighbor template region of the current block as the first motion information.

11. The image decoding method of claim 1, the method further comprising:
identifying whether an inter prediction mode of the current block is a merge mode which is a mode deriving motion information of the current block using spatially or temporally neighboring block of the current block;
if the inter prediction mode of the current block is the merge mode, identifying whether a DSMVD mode is applied to the current block, wherein the DSMVD mode indicates a mode in which a decoder derives motion information without transmitting motion-related information; and
if the DSMVD mode is applied to the current block, identifying whether the template matching is applied to the current block.

12. An image decoding apparatus based on an inter prediction, comprising:
a first motion information derivation unit for deriving first motion information of a current block by applying template matching on the current block, wherein the template matching is a mode deriving motion information minimizing a difference value between a neighbor template region of the current block and a neighbor template region of a reference block of a reference picture;
a determination unit for determining whether to perform the template matching in subblock units of the current block;
a second motion information derivation unit for deriving second motion information in subblock units by performing the template matching on a subblock of the current block if it is determined to perform the template matching in the subblock units; and
a prediction block generation unit for generating a prediction block of the current block by using the first motion information if it is determined not to perform the template matching in the subblock units, and if it is determined to perform the template matching in the subblock units, generating a prediction block of the current block by using the first motion information and the second motion information.
